(19) United States
(12) Patent Application Publication
(10) Pub. No.: US 2024/0368200 A1
(43) Pub. Date: Nov. 7, 2024

(54) PREPARATION OF IMINE-FUNCTIONAL ORGANOSILICON COMPOUNDS AND PRIMARY AMINO-FUNCTIONAL ORGANOSILICON COMPOUNDS

(71) Applicants: Dow Global Technologies LLC, Midland, MI (US); Dow Silicones Corporation, Midland, MI (US)

(72) Inventors: Erich Molitor, Midland, MI (US); Joseph Neuman, Midland, MI (US); Michael Tulchinsky, Midland, MI (US); Ruth Figueroa, Midland, MI (US); Jason Fisk, Midland, MI (US); David Devore, Midland, MI (US); Mrunmayi Kumbhalkar, Midland, MI (US); Michael Ferritto, Midland, MI (US); Michael Telgenhoff, Midland, MI (US); Brian Rekken, Midland, MI (US)

(21) Appl. No.: 18/290,892

(22) PCT Filed: Oct. 6, 2022
(86) PCT No.: PCT/US2022/077642

§ 371 Date: Jan. 22, 2024

Related U.S. Application Data
(60) Provisional application No. 63/252,639, filed on Oct. 6, 2021.

(51) Int. Cl. C07F 7/08; C08G 77/26

(52) U.S. Cl. CPC C07F 7/0889; C08G 77/26

(57) ABSTRACT

An organosilicon compound with a primary amino-functional group is prepared. A catalyzed reductive amination process for combining a secondary imine-functional organosilicon compound with ammonia and hydrogen produces the primary amino-functional organosilicon compound.

### CROSS REFERENCE TO RELATED APPLICATIONS

This application claims the benefit of U.S. Provisional Patent Application Ser. No. 63/252,639 filed on 6 Oct. 2021 under 35 U.S.C. § 119 (e). U.S. Provisional Patent Application Ser. No. 63/252,639 is hereby incorporated by reference.

### FIELD

A process for preparing a primary amino-functional organosilicon compound is disclosed. More particularly, the process for preparing the primary amino-functional organosilicon compound includes protection of an aldehyde-functional organosilicon compound via formation of an imine group from the aldehyde group and subsequent reductive amination of the imine-functional organosilicon compound with ammonia.

### INTRODUCTION

Certain amino-functional polyorganosiloxanes are useful, for example, in textile and leather treatment applications. Other amino-functional polyorganosiloxanes, such as amine-terminated polydiorganosiloxanes are useful in personal care applications, such as hair care. Amine-terminated polydiorganosiloxanes may be useful, for example, in hair conditioning applications. Amino-functional polyorganosiloxanes made by condensation may suffer from the drawback of instability as shown by viscosity changes and/or development of an ammonia odor after aging, which is undesirable for personal care applications. Traditionally, primary amino-functional polyorganosiloxanes are expensive to make by equilibration as they require costly starting materials and catalysts and require multiple process steps to complete.

Another method for making amino-functional polyorganosiloxanes uses allylamine, or a derivative that hydrolyzes into allylamine. These are used to do hydrosilylation chemistry with SiH functional polymers to form the amino-functional polyorganosiloxanes; however, this method suffers from the drawback that the amino-functional polyorganosiloxane product may contain at least trace amounts of either SiH or allylamine, either of which would have to be removed before the product can be used in any personal care applications due to toxicity of allylamine and reactivity of the SiH.

Another method of making amino-functional polyorganosiloxanes is by ammonolysis of chloropropyl terminated siloxanes. This costly, multi-step method may suffer from the drawback of leaving residual salt (i.e., ammonium chloride) in the amine-terminated polyorganosiloxane product that may require extensive washing to remove, which is cost ineffective and poorly sustainable. Also, any residual ammonium chloride may produce a foul smell, which is undesirable for personal care applications.

Therefore, there is an unmet need in the organosilicon industry need for a synthetic method to prepare a broad range of amino-functional organosilicon compounds with relatively high purity, high selectivity, and/or low cost.

### SUMMARY

A process for preparing a primary amino-functional organosilicon compound comprises combining, under conditions to effect a dehydrative imine generation reaction, starting materials comprising an aldehyde-functional organosilicon compound and a primary amine source, thereby forming a reaction product comprising an imine-functional organosilicon compound and water. The process further comprises forming the primary amino-functional organosilicon compound from the imine-functional organosilicon compound via reductive amination.

### DETAILED DESCRIPTION

In the process for preparing the primary amino-functional organosilicon compound introduced above, the aldehyde-functional organosilicon compound may be an aldehyde-functional organosilicon compound which is known and may be made by known methods, such as those described in U.S. Pat. No. 4,424,392 to Petty; U.S. Pat. No. 5,021,601 to Frances et al.; U.S. Pat. No. 5,739,246 to Graiver et al.; U.S. Pat. No. 7,696,294 to Asirvatham; and U.S. Pat. No. 7,999,053 to Sutton et al.; European Patent Application Publication EP 0 392 948 A1 to Frances, and PCT Patent Application Publication WO2006027074 to Kuhnle et al.

### Hydroformylation

Alternatively, the aldehyde-functional organosilicon compound may be prepared by a hydroformylation process according to PCT Patent Application Publication WO2022081444 to Fisk, et al. This hydroformylation process comprises: 1) combining, under conditions to catalyze hydroformylation reaction, starting materials comprising (A) a gas comprising hydrogen and carbon monoxide, (B) an alkenyl-functional organosilicon compound, and (C) hydroformylation reaction catalyst such as a rhodium/bisphosphite ligand complex catalyst, thereby forming a hydroformylation reaction product comprising the aldehyde-functional organosilicon compound.

The hydroformylation process described herein employs starting materials comprising: (A) a gas comprising hydrogen and carbon monoxide, (B) an alkenyl-functional organosilicon compound, and (C) a rhodium/bisphosphite ligand catalyst. The starting materials may optionally further comprise: (D) a solvent.

### (A) Syngas

Starting material (A), the gas used in the hydroformylation process, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO (H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (A) herein. Alternatively, the H₂:CO molar ratio in starting material (A) for use herein may be 3:1 to 1:3, alternatively 2:1 to 1:2, and alternatively 1:1.

### (B) Alkenyl-Functional Organosilicon Compound

The alkenyl-functional organosilicon compound has, per molecule, at least one alkenyl group covalently bonded to silicon. Alternatively, the alkenyl-functional organosilicon compound may have, per molecule, more than one alkenyl group covalently bonded to silicon. Starting material (B) may be one alkenyl-functional organosilicon compound. Alternatively, starting material (B) may comprise two or more alkenyl-functional organosilicon compounds that differ from one another. For example, the alkenyl-functional organosilicon compound may comprise one or both of (B1) a silane and (B2) a polyorganosiloxane.

Starting material (B1), the alkenyl-functional silane, may have formula (B1-1): R^{A}ₓSiR⁴₍₄₋ₓ₎, where each R^{A} is an independently selected alkenyl group of 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4. Alternatively, subscript x may be 1 or 2, alternatively 2, and alternatively 1. Alternatively, each R⁴ may be independently selected from the group consisting of an alkyl group of 1 to 18 carbon atoms, an aryl group of 6 to 18 carbon atoms, an acetoxy group of 2 to 18 carbon atoms, and an alkoxy-functional group of 1 to 18 carbon atoms. Alternatively, each R⁴ may be independently selected from the group consisting of an alkyl group of 1 to 18 carbon atoms, an aryl group of 6 to 18 carbon atoms, and a hydrocarbonoxy-functional group of 1 to 18 carbon atoms. Alternatively, each R⁴ may be independently selected from the group consisting of an alkyl group of 1 to 12 carbon atoms and an aryl group of 6 to 12 carbon atoms. Alternatively, each R⁴ may be independently selected from the group consisting of an alkyl group of 1 to 8 carbon atoms and an aryl group of 6 to 8 carbon atoms. Alternatively, each R⁴ in formula (B1-1) may be independently selected from the group consisting of an methyl and phenyl.

The alkenyl group for R^{A} may have terminal alkenyl functionality, e.g., R^{A} may have formula

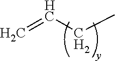

where subscript y is 0 to 6. Alternatively, each R^{A} may be independently selected from the group consisting of vinyl, allyl, and hexenyl. Alternatively, each R^{A} may be independently selected from the group consisting of vinyl and allyl. Alternatively, each R^{A} may be vinyl. Alternatively, each R^{A} may be allyl.

Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R⁴ may be selected from the group consisting of methyl, ethyl, propyl and butyl; alternatively methyl, ethyl, and propyl; alternatively methyl and ethyl. Alternatively, the alkyl group for R⁴ may be methyl.

Suitable aryl groups for R⁴ may be monocyclic or polycyclic and may have pendant hydrocarbyl groups. For example, the aryl groups for R⁴ include phenyl, tolyl, xylyl, and naphthyl and further include aralkyl groups such as benzyl, 1-phenylethyl and 2-phenylethyl. Alternatively, the aryl group for R⁴ may be monocyclic, such as phenyl, tolyl, or benzyl; alternatively the aryl group for R⁴ may be phenyl.

Suitable hydrocarbonoxy-functional groups for R⁴ may have the formula —OR⁵ or the formula —OR³—OR⁵, where each R³ is an independently selected divalent hydrocarbyl group of 1 to 18 carbon atoms, and each R⁵ is independently selected from the group consisting of the alkyl groups of 1-18 carbon atoms and the aryl groups of 6-18 carbon atoms, which are as described and exemplified above for R⁴. Examples of divalent hydrocarbyl groups for R³ include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—, or a branched alkane-diyl, e.g.,

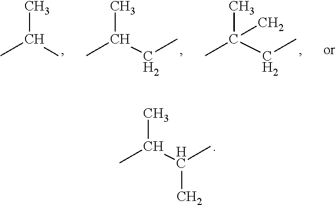

Alternatively, R³ may be an arylene group such as phenylene, or an alkylarylene group such as:

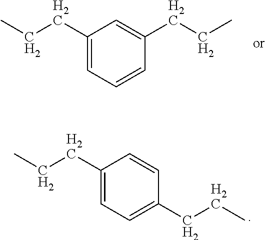

Alternatively, R³ may be a linear alkane-diyl group such as ethylene. Alternatively, the hydrocarbonoxy-functional group may be an alkoxy-functional group such as methoxy, ethoxy, propoxy, or butoxy; alternatively methoxy or ethoxy, and alternatively methoxy.

Suitable acyloxy groups for R⁴ may have the formula

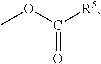

where R⁵ is as described above. Examples of suitable acyloxy groups include acetoxy. Alkenyl-functional acyloxysilanes and methods for their preparation are known in the art, for example, in U.S. Pat. No. 5,387,706 to Rasmussen, et al., and U.S. Pat. No. 5,902,892 to Larson, et al.

Suitable alkenyl-functional silanes are exemplified by alkenyl-functional trialkylsilanes such as vinyltrimethylsilane, vinyltriethylsilane, and allyltrimethylsilane; alkenyl-functional trialkoxysilanes such as allyltrimethoxysilane, vinyltrimethoxysilane, vinyltriethoxysilane, vinyltriisopropoxysilane, and vinyltris(methoxyethoxy)silane; alkenyl-functional dialkoxysilanes such as vinylphenyldiethoxysilane, vinylmethyldimethoxysilane, and vinylmethyldiethoxysilane; alkenyl-functional monoalkoxysilanes such as trivinylmethoxysilane; alkenyl-functional triacyloxysilanes such as vinyltriacetoxysilane, and alkenyl-functional diacyloxysilanes such as vinylmethyldiacetoxysilane. All of these alkenyl-functional silanes are commercially available from Gelest Inc. of Morrisville, Pennsylvania, USA. Furthermore, alkenyl-functional silanes may be prepared by known methods, such as those disclosed in U.S. Pat. No. 4,898,961 to Baile, et al. and U.S. Pat. No. 5,756,796 to Davern, et al.

Alternatively, (B) the alkenyl-functional organosilicon compound may comprise (B2) an alkenyl-functional polyorganosiloxane. Said polyorganosiloxane may be cyclic, linear, branched, resinous, or a combination of two or more thereof. Said polyorganosiloxane may comprise unit formula (B2-1): (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(SiO_{4/2})_{g}(ZO_{1/2})ₕ; where R^{A} and R⁴ are as described above; each Z is independently selected from the group consisting of a hydrogen atom and R⁵ (where R⁵ is as described above), subscripts a, b, c, d, e, f, and g represent numbers of each unit in formula (B2-1) and have values such that subscript a≥0, subscript b≥0, subscript c≥0, subscript d≥0, subscript e≥0, subscript f≥0, and subscript g≥0; a quantity (a+b+c+d+e+f+g)≥2, and a quantity (b+d+f)≥1, and subscript h has a value such that 0 h/(e+f+g)≤1.5. At the same time, the quantity (a+b+c+d+e+f+g) may be ≤10,000. Alternatively, when e=f=g=0, then h≥0. Alternatively, in formula (B-2-1), each R⁴ may be independently selected from the group consisting of a hydrogen atom, an alkyl group of 1 to 18 carbon atoms and an aryl group of 6 to 18 carbon atoms. Alternatively, each R⁴ may be independently selected from the group consisting of an alkyl group of 1 to 12 carbon atoms and an aryl group of 6 to 12 carbon atoms. Alternatively, each R⁴ may be independently selected from the group consisting of an alkyl group of 1 to 8 carbon atoms and an aryl group of 6 to 8 carbon atoms. Alternatively, each R⁴ may be independently selected from the group consisting of methyl and phenyl. Alternatively, each Z may be hydrogen or an alkyl group of 1 to 6 carbon atoms. Alternatively, each Z may be hydrogen.

Alternatively, (B2) the alkenyl-functional polyorganosiloxane may comprise (B2-2) a linear polydiorganosiloxane having, per molecule, at least one alkenyl group; alternatively at least two alkenyl groups (e.g., when in formula (B2-1) above, subscripts e=f=g=0). For example, said polydiorganosiloxane may comprise unit formula (B2-3): (R⁴₃SiO_{1/2})ₐ(R^{A}R⁴₂SiO_{1/2})_{b}(R⁴₂SiO_{2/2})_{c}(R^{A}R⁴SiO_{2/2})_{d}, where R^{A} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2. Alternatively, in unit formula (B2-3) the quantity (a+b+c+d) may be at least 3, alternatively at least 4, and alternatively >50. At the same time in unit formula (B2-3), the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in unit formula (B2-3) each R⁴ may be independently selected from the group consisting of alkyl and aryl; alternatively methyl and phenyl. Alternatively, each R⁴ in unit formula (B2-3) may be an alkyl group; alternatively each R⁴ may be methyl.

Alternatively, the polydiorganosiloxane of unit formula (B2-3) may be selected from the group consisting of: unit formula (B2-4): (R⁴₂R^{A}SiO_{1/2})₂(R⁴₂SiO_{2/2})ₘ(R⁴R^{A}SiO_{2/2})ₙ, unit formula (B2-5): (R⁴₃SiO_{1/2})₂(R⁴₂SiO_{2/2})ₒ(R⁴R^{A}SiO_{2/2})ₚ, or a combination of both (B2-4) and (B2-5).

In formulae (B2-4) and (B2-5), each R⁴ and R^{A} are as described above. Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (B2) may comprise an alkenyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl,methyl,vinyl-siloxy-terminated polydimethylsiloxane, x) bis-dimethylhexenylsiloxy-terminated polydimethylsiloxane, xi) bis-dimethylhexenylsiloxy-terminated poly(dimethylsiloxane/methylhexenylsiloxane), xii) bis-dimethylhexenylsiloxy-terminated polymethylhexenylsiloxane, xiii) bis-trimethylsiloxy-terminated poly(dimethylsiloxane/methylhexenylsiloxane), xiv) bis-trimethylsiloxy-terminated polymethylhexenylsiloxane, xv) bis-dimethylhexenyl-siloxy terminated poly(dimethylsiloxane/methylphenylsiloxane/methylhexenylsiloxane), xvi) bis-dimethylvinylsiloxy-terminated poly(dimethylsiloxane/methylhexenylsiloxane), xvii) bis-dimethylhexenyl-siloxy-terminated poly(dimethylsiloxane/methylphenylsiloxane), xviii) dimethylhexenyl-siloxy-terminated poly(dimethylsiloxane/diphenylsiloxane), and xix) a combination of two or more of i) to xviii).

Methods of preparing linear alkenyl-functional polydiorganosiloxanes described above for starting material (B2), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing linear polydiorganosiloxanes with alkenyl groups. Examples of linear polydiorganosiloxanes having alkenyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, DMS-V52.

Alternatively, (B2) the alkenyl-functional polyorganosiloxane may be cyclic, e.g., when in unit formula (B2-1), subscripts a=b=c=e=f=g=h=0. The cyclic alkenyl-functional polydiorganosiloxane may have unit formula (B2-7): (R⁴R^{A}SiO_{2/2})_{d}, where R^{A} and R⁴ are as described above, and subscript d may be 3 to 12, alternatively 3 to 6, and alternatively 4 to 5. Examples of cyclic alkenyl-functional polydiorganosiloxanes include 2,4,6-trimethyl-2,4,6-trivinyl-cyclotrisiloxane, 2,4,6,8-tetramethyl-2,4,6,8-tetravinyl-cyclotetrasiloxane, 2,4,6,8,10-pentamethyl-2,4,6,8,10-pentavinyl-cyclopentasiloxane, and 2,4,6,8,10,12-hexamethyl-2,4,6,8,10,12-hexavinyl-cyclohexasiloxane. These cyclic alkenyl-functional polydiorganosiloxanes are known in the art and are commercially available from, e.g., Sigma-Aldrich of St. Louis, Missouri, USA; Milliken of Spartanburg, South Carolina, USA; and other vendors.

Alternatively, the cyclic alkenyl-functional polydiorganosiloxane may have unit formula (B2-8): (R⁴₂SiO_{2/2})_{c}(R⁴R^{A}SiO_{2/2})_{d}, where R⁴ and R^{A} are as described above, subscript c is >0 to 6 and subscript d is 3 to 12. Alternatively, in formula (B2-8), c may be 3 to 6, and d may be 3 to 6.

Alternatively, (B2) the alkenyl-functional polyorganosiloxane may be oligomeric, e.g., when in unit formula (B2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (B2-6).

Examples of linear alkenyl-functional polyorganosiloxane oligomers may have formula (B2-10):

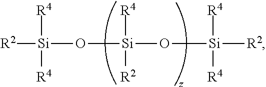

where R⁴ is as described above, each R² is independently selected from the group consisting of R⁴ and R^{A}, with the proviso that at least one R², per molecule, is R^{A}, and subscript z is 0 to 48. Alternatively, subscript z may be 0 to 4, alternatively 0 or 1; and alternatively 0. Alternatively, when z=0 in formula (B2-10), the alkenyl-functional polyorganosiloxane oligomer may have formula (B2-10a):

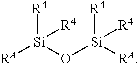

Examples of linear alkenyl-functional polyorganosiloxane oligomers may have include 1,3-divinyl-1,1,3,3-tetramethyldisiloxane; 1,1,1,3,3-pentamethyl-3-vinyl-disiloxane; 1,1,1,3,5,5,5-heptamethyl-3-vinyl-trisiloxane, all of which are commercially available, e.g., from Gelest, Inc. of Morrisville, Pennsylvania, USA or Sigma-Aldrich of St. Louis, Missouri, USA.

Alternatively, the alkenyl-functional polyorganosiloxane oligomer may be branched. The branched oligomer may have general formula (B2-11): R^{A}SiR¹²₃, where R^{A} is as described above and each R¹² is selected from R¹³ and —OSi(R¹⁴)₃; where each R¹³ is a monovalent hydrocarbon group (e.g., which may be an alkyl group of 1 to 18 carbon atoms or an aryl group of 6 to 18 carbon atoms, as described an exemplified above for R⁴); where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (B2-11) when each R¹² is R¹³, the branched polyorganosiloxane oligomer has the following structure (B2-11a):

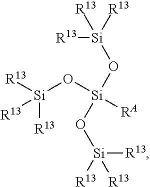

where R^{A} and R¹³ are as described above. Alternatively, in formula (B2-11a), each R^{A} may be vinyl, allyl, or hexenyl, and each R¹³ may be methyl.

Alternatively, in formula (B2-11) when each R¹² is —OSi(R¹⁴)₃, each R¹⁴ may be —OSi(R¹⁵)₃ moieties such that the branched polyorganosiloxane oligomer has the following structure (B2-11b):

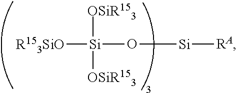

where R^{A} and R¹⁵ are as described above. Alternatively, each R¹⁵ may be an R¹³, as described above, and each R¹³ may be methyl.

Alternatively, in formula (B2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴) may each be —OSi(R¹⁵)₃ moieties such that the branched poly organosiloxane oligomer has the following structure (B2-11c):

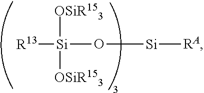

where R^{A}, R¹³, and R¹⁵ are as described above. Alternatively, each R¹⁵ may be an R¹³, and each R¹³ may be methyl.

Alternatively, in formula (B2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of are —OSiR¹³(R¹⁴)₂. Alternatively, each R¹⁴ in —OSiR¹³(R¹⁴)₂ may be —OSi(R⁵)₃ such that the branched polyorganosiloxane oligomer has the following structure (B2-11d):

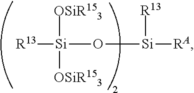

where R^{A}, R¹³, and R¹⁵ are as described above. Alternatively, each R¹⁵ may be an R¹³, and each R¹³ may be methyl. Alternatively, the alkenyl-functional branched polyorganosiloxane may have 3 to 16 silicon atoms per molecule, alternatively 4 to 16 silicon atoms per molecule, and alternatively 4 to 10 silicon atoms per molecule. Examples of alkenyl-functional branched polyorganosiloxane oligomers include 1,1,1,5,5,5-hexamethyl-3-((trimethylsilyl)oxy)-3-vinyltrisiloxane, which has formula:

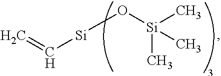

vinyl-tris(trimethyl)siloxy)silane, which has formula:

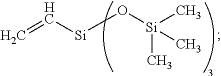

methyl-vinyl-di((1,1,1,3,5,5,5-heptamethyltrisiloxan-3-yl)oxy)-silane, which has formula

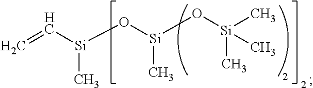

vinyl-tris((1,1,1,3,5,5,5-heptamethyltrisiloxan-3-yl)oxy)-silane, which has formula

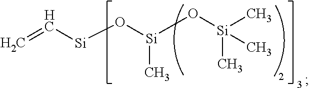

and (hex-5-en-1-yl)-tris((1,1,1,3,5,5,5-heptamethyltrisiloxan-3-yl)oxy)-silane, which has formula

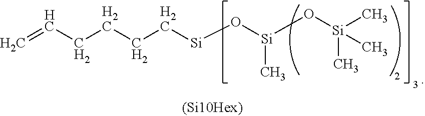

Branched alkenyl-functional polyorganosiloxane oligomers described above may be prepared by known methods, such as those disclosed in “Testing the Functional Tolerance of the Piers-Rubinsztajn Reaction: A new Strategy for Functional Silicones” by Grande, et al. Supplementary Material (ESI) for Chemical Communications, © The Royal Society of Chemistry 2010.

Alternatively, (B2) the alkenyl-functional polyorganosiloxane may be branched, such as the branched oligomer described above and/or a branched alkenyl-functional polyorganosiloxane that may have, e.g., more alkenyl groups per molecule and/or more polymer units than the branched oligomer described above (e.g., in formula (B2-1) when the quantity (a+b+c+d+e+f+g)>50). The branched alkenyl-functional polyorganosiloxane may have (in formula (B2-1)) a quantity (e+f+g) sufficient to provide >0 to 5 mol % of trifunctional and/or quadrifunctional units to the branched alkenyl-functional polyorganosiloxane.

For example, the branched alkenyl-functional polyorganosiloxane may comprise a Q branched polyorganosiloxane of unit formula (B2-13): (R⁴₃SiO_{1/2})_{q}(R⁴₂R^{A}SiO_{1/2})ᵣ(R⁴₂SiO_{2/2})ₛ(SiO_{4/2})ₜ, where R⁴ and R^{A} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa·s measured by rotational viscometry (as described below with the test methods) to the branched polyorganosiloxane. Alternatively, viscosity may be >170 mPa·s to 1000 mPa·s, alternatively >170 to 500 mPa·s, alternatively 180 mPa·s to 450 mPa·s, and alternatively 190 mPa·s to 420 mPa·s. Suitable Q branched polyorganosiloxanes for starting material (B2-12) are known in the art and can be made by known methods, exemplified by those disclosed in U.S. Pat. No. 6,806,339 to Cray, et al. and U.S. Patent Publication 2007/0289495 to Cray, et al.

Alternatively, the branched alkenyl-functional polyorganosiloxane may comprise formula (B2-14): [R^{A}R⁴₂Si—(O—SiR⁴₂)ₓ—O]_{(4-w)}—Si—[O—(R⁴₂SiO)ᵥSiR⁴₃]_{w}, where R^{A} and R⁴ are as described above; and subscripts v, w, and x have values such that 200≥v≥1, 2≥w≥0, and 200≥x≥1. Alternatively, in this formula (B2-14), each R⁴ is independently selected from the group consisting of methyl and phenyl, and each R^{A} is independently selected from the group consisting of vinyl, allyl, and hexenyl. Branched polyorganosiloxane suitable for starting material (B2-14) may be prepared by known methods such as heating a mixture comprising a polyorganosilicate resin, and a cyclic polydiorganosiloxane or a linear polydiorganosiloxane, in the presence of a catalyst, such as an acid or phosphazene base, and thereafter neutralizing the catalyst.

Alternatively, the branched alkenyl-functional polyorganosiloxane for starting material (B2-11) may comprise a T branched polyorganosiloxane (silsesquioxane) of unit formula (B2-15): (R⁴₃SiO_{1/2})ₐₐ(R^{A}R⁴₂SiO_{1/2})_{bb}(R⁴₂SiO_{2/2})_{cc}(R^{A}R⁴SiO_{2/2})ₑₑ(R⁴SiO_{3/2})_{dd}, where R⁴ and R^{A} are as described above, subscript aa≥0, subscript bb≥0, subscript cc is 15 to 995, subscript dd>0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb≥0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may b 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd≥0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (B2-15) with an alkenyl content of 0.1% to 1%, alternatively 0.2% to 0.6%, based on the weight of the silsesquioxane. Suitable T branched polyorganosiloxanes (silsesquioxanes) for starting material (B2-15) are exemplified by those disclosed in U.S. Pat. No. 4,374,967 to Brown, et al; U.S. Pat. No. 6,001,943 to Enami, et al.; U.S. Pat. No. 8,546,508 to Nabeta, et al.; and U.S. Pat. No. 10,155,852 to Enami.

Alternatively, (B2) the alkenyl-functional polyorganosiloxane may comprise an alkenyl-functional polyorganosilicate resin, which comprises monofunctional units (“M” units) of formula R^{M}₃SiO_{1/2} and tetrafunctional silicate units (“Q” units) of formula SiO_{4/2}, where each R^{M} is an independently selected monovalent hydrocarbon group; each R^{M} may be independently selected from the group consisting of R⁴ and R^{A} as described above. Alternatively, each R^{M} may be selected from the group consisting of alkyl, alkenyl, and aryl. Alternatively, each R^{M} may be selected from methyl, vinyl, and phenyl. Alternatively, at least one-third, alternatively at least two thirds of the R^{M} groups are methyl groups. Alternatively, the M units may be exemplified by (Me₃SiO_{1/2}), (Me₂PhSiO_{1/2}), and (Me₂ViSiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M}₃)₄, where R^{M} is as described above, e.g., the neopentamer may be tetrakis(trimethylsiloxy)silane. ²⁹Si NMR and ¹³C NMR spectroscopies may be used to measure hydroxyl and alkoxy content and molar ratio of M and Q units, where said ratio is expressed as {M(resin)}/{Q(resin)}, excluding M and Q units from the neopentamer. M/Q ratio represents the molar ratio of the total number of triorganosiloxy groups (M units) of the resinous portion of the polyorganosilicate resin to the total number of silicate groups (Q units) in the resinous portion. M/Q ratio may be 0.5/1 to 1.5/1, alternatively 0.6/1 to 0.9/1.

The Mn of the polyorganosilicate resin depends on various factors including the types of hydrocarbon groups represented by R^{M} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da; alternatively 1,500 Da to 15,000 Da; alternatively >3,000 Da to 8,000 Da. Alternatively, Mn of the polyorganosilicate resin may be 3,500 Da to 8,000 Da.

U.S. Pat. No. 8,580,073 at col. 3, line 5 to col. 4, line 31, and U.S. Patent Publication 2016/0376482 at paragraphs [0023] to [0026] are hereby incorporated by reference for disclosing MQ resins, which are suitable polyorganosilicate resins for use as starting material (B2). The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M units and Q units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX, where R^{M} is as described above and X represents a hydroxyl group or a hydrolyzable substituent, e.g., of formula OZ described above. Silanes with four hydrolyzable substituents may have formula SiX′₄, where each X′ is independently selected from the group consisting of halogen, alkoxy, and hydroxyl. Suitable alkali metal silicates include sodium silicate.

The polyorganosilicate resin prepared as described above typically contain silicon bonded hydroxyl groups, e.g., of formula, HOSiO_{3/2}. The polyorganosilicate resin may comprise up to 3.5% of silicon bonded hydroxyl groups, as measured by FTIR spectroscopy and/or NMR spectroscopy, as described above. For certain applications, it may desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprise 2% or less, alternatively 0.7% or less, and alternatively 0.3% or less, and alternatively 0.3% to 0.8% of units containing hydroxyl groups, e.g., those represented by formula XSiO_{3/2} where R^{M} is as described above, and X represents a hydrolyzable substituent, e.g., OH. The concentration of silanol groups (where X═OH) present in the polyorganosilicate resin may be determined using FTIR spectroscopy and/or NMR as described above.

For use herein, the polyorganosilicate resin further comprises one or more terminal alkenyl groups per molecule. The polyorganosilicate resin having terminal alkenyl groups may be prepared by reacting the product of Daudt, et al. with an alkenyl group-containing endblocking agent and an endblocking agent free of aliphatic unsaturation, in an amount sufficient to provide from 3 to 30 mole percent of alkenyl groups in the final product. Examples of endblocking agents include, but are not limited to, silazanes, siloxanes, and silanes. Suitable endblocking agents are known in the art and exemplified in U.S. Pat. No. 4,584,355 to Blizzard, et al.; U.S. Pat. No. 4,591,622 to Blizzard, et al.; and 4,585,836 to Homan, et al. A single endblocking agent or a mixture of such agents may be used to prepare such resin.

Alternatively, the polyorganosilicate resin may comprise unit formula (B2-17): (R⁴₃SiO_{1/2})ₘₘ(R⁴₂R^{A}SiO_{1/2})ₙₙ(SiO_{4/2})ₒₒ(ZO_{1/2})ₕ, where Z, R⁴, and R^{A}, and subscript h are as described above and subscripts mm, nn and oo have average values such that mm≥0, nn≥0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (B2) the alkenyl-functional polyorganosiloxane may comprise (B2-18) an alkenyl-functional silsesquioxane resin, i.e., a resin containing trifunctional (T) units of unit formula: (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})(ZO_{1/2})ₕ; where R⁴ and R^{A} are as described above, subscript f>1, 2<(e+f)<10,000; 0<(a+b)/(e+f)<3; 0<(c+d)/(e+f)<3; and 0<h/(e+f)<1.5. Alternatively, the alkenyl-functional silsesquioxane resin may comprise unit formula (B2-19): (R⁴SiO_{3/2})ₑ(R^{A}SiO_{3/2})_{f}(ZO_{1/2})ₕ, where R⁴, R^{A}, Z, and subscripts h, e and f are as described above. Alternatively, the alkenyl-functional silsesquioxane resin may further comprise difunctional (D) units of formulae (R⁴₂SiO_{2/2})_{c}(R⁴R^{A}SiO_{2/2})_{d} in addition to the T units described above, i.e., a DT resin, where subscripts c and d are as described above. Alternatively, the alkenyl-functional silsesquioxane resin may further comprise monofunctional (M) units of formulae (R⁴₃SiO_{1/2})ₐ(R⁴₂R^{A}SiO_{1/2})_{b}, i.e., an MDT resin, where subscripts a and b are as described above for unit formula (B2-1).

Alkenyl-functional silsesquioxane resins are commercially available, for example. RMS-310, which comprises unit formula (B2-20): (Me₂ViSiO_{1/2})₂₅(PhSiO_{3/2})₇₅ dissolved in toluene, is commercially available from DSC. Alkenyl-functional silsesquioxane resins may be produced by the hydrolysis and condensation or a mixture of trialkoxy silanes using the methods as set forth in “Chemistry and Technology of Silicone” by Noll, Academic Press, 1968, chapter 5, p 190-245. Alternatively, alkenyl-functional silsesquioxane resins may be produced by the hydrolysis and condensation of a trichlorosilane using the methods as set forth in U.S. Pat. No. 6,281,285 to Becker, et al. and U.S. Pat. No. 5,010,159 to Bank, et al. Alkenyl-functional silsesquioxane resins comprising D units may be prepared by known methods, such as those disclosed in U.S. Patent Application 2020/0140619 and PCT Publication WO2018/204068 to Swier, et al.

Alternatively, starting material (B) the alkenyl-functional organosilicon compound may comprise (B3) an alkenyl-functional silazane. The alkenyl-functional silazane may have formula (B3-1): [(R¹_{(3-gg)}R^{A}_{gg}Si)_{ff}NH_{(3-ff)}]ₕₕ, where R^{A} is as described above; each R¹ is independently selected from the group consisting of an alkyl group and an aryl group; each subscript ff is independently 1 or 2; and subscript gg is independently 0, 1, or 2; where 1<hh<10. For R¹, the alkyl group and the aryl group may be the alkyl group and the aryl group as described above for R⁴. Alternatively, subscript hh may have a value such that 1<hh 6. Examples of alkenyl-functional silazanes include, MePhViSiNH₂, Me₂ViSiNH₂, (ViMe₂Si)₂NH, (MePhViSi)₂NH. Alkenyl-functional silazanes may be prepared by known methods, for example, reacting an alkenyl-functional halosilane with ammonia under anhydrous or substantially anhydrous conditions, and thereafter distilling the resulting reaction mixture to separate cyclic alkenyl-functional silazanes and linear alkenyl-functional silazanes, such as those disclosed in U.S. Pat. No. 2,462,635 to Haber; U.S. Pat. No. 3,243,404 to Martellock; and PCT Publication No. WO83/02948 to Dziark. Suitable alkenyl-functional silazanes are commercially available, for example, 2,4,6-trimethyl-2,4,6-trivinylcyclotrisilazane (MeViSiNH)₃ is available from Sigma-Aldrich of St. Louis, MO, USA; sym-tetramethyldivinyldisilazane (ViMe₂Si)₂NH is available from Alfa Aesar; and 1,3-divinyl-1,3-diphenyl-1,3-dimethyldisilazane (MePhViSi)₂NH is available from Gelest, Inc. of Morrisville, Pennsylvania, USA.

Starting material (B) may be any one of the alkenyl-functional organosilicon compounds described above. Alternatively, starting material (B) may comprise a mixture of two or more of the alkenyl-functional organosilicon compounds.

### (C) Hydroformylation Reaction Catalyst

Starting material (C), the hydroformylation reaction catalyst for use herein comprises an activated complex of rhodium and a close ended bisphosphite ligand. The bisphosphite ligand may be symmetric or asymmetric. Alternatively, the bisphosphite ligand may be symmetric. The bisphosphite ligand may have formula (C1):

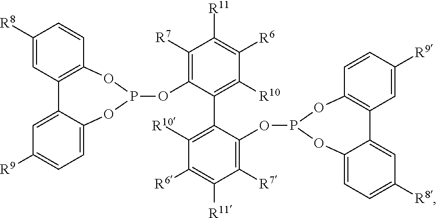

where R⁶ and R^{6′} are each independently selected from the group consisting of hydrogen, an alkyl group of at least one carbon atom, a cyano group, a halogen group, and an alkoxy group of at least one carbon atom; R⁷ and R^{7′} are each independently selected from the group consisting of an alkyl group of at least 3 carbon atoms and a group of formula —SiR¹⁷₃, where each R¹⁷ is an independently selected monovalent hydrocarbon group of 1 to 20 carbon atoms; R⁸, R^{8′}, R⁹, and R^{9′} are each independently selected from the group consisting of hydrogen, an alkyl group, a cyano group, a halogen group, and an alkoxy group; and R¹⁰, R^{10′}, R¹¹, and R^{11′} are each independently selected from the group consisting of hydrogen and an alkyl group. Alternatively, one of R⁷ and R^{7′} may be hydrogen.

In formula (C1), R⁶ and R^{6′} may be alkyl groups of least one carbon atom, alternatively 1 to 20 carbon atoms. Suitable alkyl groups for R⁶ and R^{6′} may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁶ and R^{6′} may be selected from the group consisting of ethyl, propyl and butyl; alternatively propyl and butyl. Alternatively, the alkyl group for R⁶ and R^{6′} may be butyl. Alternatively, R⁶ and R^{6′} may be alkoxy groups, wherein the alkoxy group may have formula —OR^{6″}, where R^{6″} is an alkyl group as described above for R⁶ and R^{6′}.

Alternatively, in formula (C1), R⁶ and R^{6′} may be independently selected from alkyl groups of 1 to 6 carbon atoms and alkoxy groups of 1 to 6 carbon atoms. Alternatively, R⁶ and R^{6′} may be alkyl groups of 2 to 4 carbon atoms. Alternatively, R⁶ and R^{6′} may be alkoxy groups of 1 to 4 carbon atoms. Alternatively, R⁶ and R^{6′} may be butyl groups, alternatively tert-butyl groups. Alternatively, R⁶ and R^{6′} may be methoxy groups.

In formula (C1), R⁷ and R^{7′} may be alkyl groups of least three carbon atoms, alternatively 3 to 20 carbon atoms. Suitable alkyl groups for R⁷ and R^{7′} may be linear, branched, cyclic, or combinations of two or more thereof. The alkyl groups are exemplified by propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁷ and R^{7′} may be selected from the group consisting of propyl and butyl. Alternatively, the alkyl group for R⁷ and R^{7′} may be butyl.

Alternatively, in formula (C1), R⁷ and R^{7′} may be a silyl group of formula —SiR¹⁷₃, where each R¹⁷ is an independently selected monovalent hydrocarbon group of 1 to 20 carbon atoms. The monovalent hydrocarbon group may be an alkyl group of 1 to 20 carbon atoms, as described above for R⁶ and R^{6′}.

Alternatively, in formula (C1), R⁷ and R^{7′} may each be independently selected alkyl groups, alternatively alkyl groups of 3 to 6 carbon atoms. Alternatively, R⁷ and R^{7′} may be alkyl groups of 3 to 4 carbon atoms. Alternatively, R⁷ and R^{7′} may be butyl groups, alternatively tert-butyl groups.

In formula (C1), R⁸, R^{8′}, R⁹, R^{9′} may be alkyl groups of at least one carbon atom, as described above for R⁶ and R^{6′}. Alternatively, R⁸ and R^{8′} may be independently selected from the group consisting of hydrogen and alkyl groups of 1 to 6 carbon atoms. Alternatively, R⁸ and R^{8′} may be hydrogen. Alternatively, in formula (C1), R^{9′} and R^{9′} may be independently selected from the group consisting of hydrogen and alkyl groups of 1 to 6 carbon atoms. Alternatively, R⁹ and R^{9′} may be hydrogen.

In formula (C1), R¹⁰ and R^{10′} may be hydrogen atoms or alkyl groups of least one carbon atom, alternatively 1 to 20 carbon atoms. The alkyl groups for R¹⁰ and R^{10′} may be as described above for R⁶ and R^{6′}. Alternatively, R¹⁰ and R^{10′} may be methyl. Alternatively, R¹⁰ and R^{10′} may be hydrogen.

In formula (C1), R¹¹ and R^{11′} may be hydrogen atoms or alkyl groups of least one carbon atom, alternatively 1 to 20 carbon atoms. The alkyl groups for R¹¹ and R^{11′} may be as described above for R⁶ and R^{6′}. Alternatively, R¹¹ and R^{11′} may be hydrogen.

Alternatively, the ligand of formula (C1) may be selected from the group consisting of (C1-1) 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin; (C1-2) 6,6′-[(3,3′-di-tert-butyl-5,5′-dimethoxy-1,1′-biphenyl-2,2′-diyl)bis(oxy)]bis(dibenzo[d,f][1,3,2]dioxaphosphepin); and a combination of both (C1-1) and (C1-2).

Alternatively, the ligand may comprise 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin, as disclosed at col. 11 of U.S. Pat. No. 10,023,516 (see also U.S. Pat. No. 7,446,231, which discloses this compound as Ligand D at col. 22 and U.S. Pat. No. 5,727,893 at col. 20, lines 40-60 as ligand F).

Alternatively, the ligand may comprise biphephos, which is commercially available from Sigma Aldrich and may be prepared as described in U.S. Pat. No. 9,127,030. (See also U.S. Pat. No. 7,446,231 ligand B at col. 21 and U.S. Pat. No. 5,727,893 at col. 20, lines 5-18 as ligand D).

Starting material (C), the rhodium/bisphosphite ligand complex catalyst, may be prepared by methods known in the art, such as those disclosed in U.S. Pat. No. 4,769,498 to Billig, et al. at col. 20, line 50—col. 21, line 40 and U.S. Pat. No. 10,023,516 to Brammer et al. col. 11, line 35—col. 12, line 12 by varying appropriate starting materials. For example, the rhodium/bisphosphite ligand complex may be prepared by a process comprising combining a rhodium precursor and the bisphosphite ligand (C1) described above under conditions to form the complex, which complex may then be introduced into a hydroformylation reaction medium comprising one or both of starting materials (A) and/or (B), described above. Alternatively, the rhodium/bisphosphite ligand complex may be formed in situ by introducing the rhodium catalyst precursor into the reaction medium, and introducing (C1) the bisphosphite ligand into the reaction medium (e.g., before, during, and/or after introduction of the rhodium catalyst precursor), for the in situ formation of the rhodium/bisphosphite ligand complex. The rhodium/bisphosphite ligand complex can be activated by heating and/or exposure to starting material (A) to form the (C) rhodium/bisphosphite ligand complex catalyst. Rhodium catalyst precursors are exemplified by rhodium dicarbonyl acetylacetonate, Rh₂O₃, Rh₄(CO)₁₂, Rh₆(CO)₁₆, and Rh(NO₃)₃.

For example, a rhodium precursor, such as rhodium dicarbonyl acetylacetonate, optionally starting material (D), a solvent, and (C1) the bisphosphite ligand may be combined, e.g., by any convenient means such as mixing. The resulting rhodium/bisphosphite ligand complex may be introduced into the reactor, optionally with excess bisphosphite ligand. Alternatively, the rhodium precursor, (D) the solvent, and the bisphosphite ligand may be combined in the reactor with starting material (A) and/or (B), the alkenyl-functional organosilicon compound; and the rhodium/bisphosphite ligand complex may form in situ. The relative amounts of bisphosphite ligand and rhodium precursor are sufficient to provide a molar ratio of bisphosphite ligand/Rh of 10/1 to 1/1, alternatively 5/1 to 1/1, alternatively 3/1 to 1/1, alternatively 2.5/1 to 1.5/1. In addition to the rhodium/bisphosphite ligand complex, excess (e.g., not complexed) bisphosphite ligand may be present in the reaction mixture. The excess bisphosphite ligand may be the same as, or different from, the bisphosphite ligand in the complex.

The amount of (C) the rhodium/bisphosphite ligand complex catalyst (catalyst) is sufficient to catalyze hydroformylation of (B) the alkenyl-functional organosilicon compound. The exact amount of catalyst will depend on various factors including the type of alkenyl-functional organosilicon compound selected for starting material (B), its exact alkenyl content, and the reaction conditions such as temperature and pressure of starting material (A). However, the amount of (C) the catalyst may be sufficient to provide a rhodium metal concentration of at least 0.1 ppm, alternatively 0.15 ppm, alternatively 0.2 ppm, alternatively 0.25 ppm, and alternatively 0.5 ppm, based on the weight of (B) the alkenyl-functional organosilicon compound. At the same time, the amount of (C) the catalyst may be sufficient to provide a rhodium metal concentration of up to 300 ppm, alternatively up to 100 ppm, alternatively up to 20 ppm, and alternatively up to 5 ppm, on the same basis. Alternatively, the amount of (C) the catalyst may be sufficient to provide 0.1 ppm to 300 ppm, alternatively 0.2 ppm to 100 ppm, alternatively, 0.25 ppm to 20 ppm, and alternatively 0.5 ppm to 5 ppm, based on the weight of (B) the alkenyl-functional organosilicon compound.

### Solvent

The hydroformylation reaction may run without additional solvents. Alternatively, the hydroformylation reaction may be carried out with a solvent, for example to facilitate mixing and/or delivery of one or more of the starting materials described above, such as the (C) catalyst and/or starting material (B), when, e.g., an alkenyl-functional polyorganosilicate resin is selected for starting material (B). The solvent is exemplified by aliphatic or aromatic hydrocarbons, which can dissolve the starting materials, e.g., toluene, xylene, benzene, hexane, heptane, decane, cyclohexane, or a combination of two or more thereof. Additional solvents include THF, dibutyl ether, diglyme, and Texanol. Without wishing to be bound by theory, it is thought that solvent may be used to reduce the viscosity of the starting materials. The amount of solvent is not critical, however, when present, the amount of solvent may be 5% to 70% based on weight of starting material (B) the alkenyl-functional organosilicon compound.

### Hydroformylation Reaction Conditions

In the process described herein, step 1) is performed at relatively low temperature. For example, step 1) may be performed at a temperature of at least 30° C., alternatively at least 50° C., and alternatively at least 70° C. At the same time, the temperature in step 1) may be up to 150° C.; alternatively up to 100° C.; alternatively up to 90° C., and alternatively up to 80° C. Without wishing to be bound by theory, it is thought that lower temperatures, e.g., 30° C. to 90° C., alternatively 40° C. to 90° C., alternatively 50° C. to 90° C., alternatively 60° C. to 90° C., alternatively 70° C. to 90° C., alternatively 80° C. to 90° C., alternatively 30° C. to 60° C., alternatively 50° C. to 60° C. may be desired for achieving high selectivity and ligand stability.

In the process described herein, step 1) may be performed at a pressure of at least 101 kPa (ambient), alternatively at least 206 kPa (30 psi), and alternatively at least 344 kPa (50 psi). At the same time, pressure in step 1) may be up to 6,895 kPa (1,000 psi), alternatively up to 1,379 kPa (200 psi), alternatively up to 1000 kPa (145 psi), and alternatively up to 689 kPa (100 psi). Alternatively, step 1) may be performed at 101 kPa to 6,895 kPa; alternatively 344 kPa to 1,379 kPa; alternatively 101 kPa to 1,000 kPa; and alternatively 344 kPa to 689 kPa. Without wishing to be bound by theory, it is thought that using relatively low pressures, e.g., <to 6,895 kPa in the process herein may be beneficial; the ligands described herein allow for low pressure hydroformylation processes, which have the benefits of lower cost and better safety than high pressure hydroformylation processes.

The hydroformylation process may be carried out in a batch, semi-batch, or continuous mode, using one or more suitable reactors, such as a fixed bed reactor, a fluid bed reactor, a continuous stirred tank reactor (CSTR), or a slurry reactor. The selection of (B) the alkenyl-functional organosilicon compound, and (C) the catalyst, and whether (D) the solvent, is used may impact the size and type of reactor used. One reactor, or two or more different reactors, may be used. The hydroformylation process may be conducted in one or more steps, which may be affected by balancing capital costs and achieving high catalyst selectivity, activity, lifetime, and ease of operability, as well as the reactivity of the particular starting materials and reaction conditions selected, and the desired product.

Alternatively, the hydroformylation process may be performed in a continuous manner. For example, the process used may be as described in U.S. Pat. No. 10,023,516 except that the olefin feed stream and catalyst described therein are replaced with (B) the alkenyl-functional organosilicon compound and (C) the rhodium/bisphosphite ligand complex catalyst, each described herein.

Step 1) of the hydroformylation process forms a reaction fluid comprising the aldehyde-functional organosilicon compound. The reaction fluid may further comprise additional materials, such as those which have either been deliberately employed, or formed in situ, during step 1) of the process. Examples of such materials that can also be present include unreacted (B) alkenyl-functional organosilicon compound, unreacted (A) carbon monoxide and hydrogen gases, and/or in situ formed side products, such as ligand degradation products and adducts thereof, and high boiling liquid aldehyde condensation byproducts, as well as (D) a solvent, if employed. The term “ligand degradation product” includes but is not limited to any and all compounds resulting from one or more chemical transformations of at least one of the ligand molecules used in the process.

The hydroformylation process may further comprise one or more additional steps such as: 2) recovering (C) the rhodium/bisphosphite ligand complex catalyst from the hydroformylation reaction product comprising the aldehyde-functional organosilicon compound. Recovering (C) the rhodium/bisphosphite ligand complex catalyst may be performed by methods known in the art, including but not limited to adsorption and/or membrane separation (e.g., nanofiltration). Suitable recovery methods are as described, for example, in U.S. Pat. No. 5,681,473 to Miller, et al.; U.S. Pat. No. 8,748,643 to Priske, et al.; and 10,155,200 to Geilen, et al.

However, one benefit of the process described herein is that (C) the catalyst need not be removed and recycled. Due to the low level of Rh needed, it may be more cost effective not to recover and recycle (C) the catalyst; and the aldehyde-functional organosilicon compound produced by the process may be stable even when the catalyst is not removed. Therefore, alternatively, the process described above may be performed without step 2).

Alternatively, the hydroformylation process may further comprise 3) purification of the reaction product. For example, the aldehyde-functional organosilicon compound may be isolated from the additional materials, described above, by any convenient means such as stripping and/or distillation, optionally with reduced pressure.

### Aldehyde-Functional Organosilicon Compound

The aldehyde-functional organosilicon compound is useful as a starting material in the process for preparing an amino-functional organosilicon compound. Starting material (E) is the aldehyde-functional organosilicon compound, which has, per molecule, at least one aldehyde-functional group covalently bonded to silicon. Alternatively, the aldehyde-functional organosilicon compound may have, per molecule, more than one aldehyde-functional group covalently bonded to silicon. The aldehyde-functional group covalently bonded to silicon may have formula:

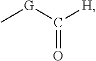

where G is a divalent hydrocarbon group free of aliphatic unsaturation that has 2 to 8 carbon atoms. G may be linear or branched. Examples of divalent hydrocarbyl groups for G include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—, or a branched alkane-diyl, e.g.,

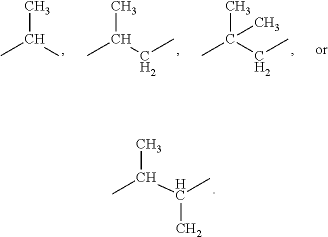

Alternatively, each G may be an alkane-diyl group of 2 to 6 carbon atoms; alternatively of 2, 3, or 6 carbon atoms. The aldehyde-functional organosilicon compound may be one aldehyde-functional organosilicon compound. Alternatively, two or more aldehyde-functional organosilicon compounds that differ from one another may be used in the process described herein. For example, the aldehyde-functional organosilicon compound may comprise one or both of an aldehyde-functional silane and an aldehyde-functional polyorganosiloxane.

The aldehyde-functional organosilicon compound may comprise (E1) an aldehyde-functional silane of formula (E1-1): R^{Ald}ₓSiR⁴₍₄₋ₓ₎, where each R^{Ald} is an independently selected group of the formula

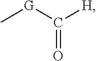

as described above; and R⁴ and subscript x are as described above. Alternatively, each R⁴ may be independently selected from the group consisting of an alkyl group of 1 to 18 carbon atoms and an aryl group of 6 to 18 carbon atoms. Alternatively, subscript x may be 1 to 4.

Suitable aldehyde-functional silanes are exemplified by aldehyde-functional trialkylsilanes such as (propyl-aldehyde)-trimethylsilane, (propyl-aldehyde)-triethylsilane, and (butyl-aldehyde)trimethylsilane.

Alternatively, the aldehyde-functional organosilicon compound may comprise (E2) an aldehyde-functional polyorganosiloxane. Said aldehyde-functional polyorganosiloxane may be cyclic, linear, branched, resinous, or a combination of two or more thereof. Said aldehyde-functional polyorganosiloxane may comprise unit formula (E2-1): (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(SiO_{4/2})_{g}(ZO_{1/2})ₕ; where each R^{Aid} is an independently selected aldehyde group of the formula

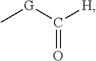

as described above, and G, R⁴, Z, and subscripts a, b, c, d, e, f, g, and h are as described above.

Alternatively, (E2) the aldehyde-functional polyorganosiloxane may comprise (E2-2) a linear polydiorganosiloxane having, per molecule, at least one aldehyde-functional group; alternatively at least two aldehyde-functional groups (e.g., when in the formula (E2-1) for the aldehyde-functional polyorganosiloxane above, subscripts e=f=g=0). For example, said polydiorganosiloxane may comprise unit formula (E2-3): (R⁴₃SiO_{1/2})ₐ(R^{Ald}R⁴₂SiO_{1/2})_{b}(R⁴₂SiO_{2/2})_{c}(R^{Ald}R⁴SiO_{2/2})_{d}, where R^{Ald} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2. Alternatively, in the unit formula (E2-3) for the linear aldehyde-functional polyorganosiloxane, above, the quantity (a+b+c+d) may be at least 3, alternatively at least 4, and alternatively >50. At the same time in said formula, the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in the unit formula for the linear aldehyde-functional polyorganosiloxane, each R⁴ may be independently selected from the group consisting of alkyl and aryl; alternatively methyl and phenyl. Alternatively, each R⁴ in said formula may be an alkyl group; alternatively each R⁴ may be methyl.

Alternatively, the linear aldehyde-functional polydiorganosiloxane of unit formula (E2-3) may be selected from the group consisting of: unit formula (E2-4): (R⁴₂R^{Ald}SiO_{1/2})₂(R⁴₂SiO_{2/2})ₘ(R⁴R^{Ald}SiO_{2/2})ₙ, unit formula (E2-5): (R⁴₃SiO_{1/2})₂(R⁴₂SiO_{2/2})ₒ(R⁴R^{Ald}SiO_{2/2})ₚ, or a combination of both (E2-4) and (E2-5).

In formulae (E2-4) and (E2-5), each R⁴ and R^{Ald} are as described above. Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (E2) may comprise an aldehyde-functional polydiorganosiloxane such as i) bis-dimethyl(propyl-aldehyde)siloxy-terminated polydimethylsiloxane, ii) bis-dimethyl(propyl-aldehyde)siloxy-terminated poly(dimethylsiloxane/methyl(propyl-aldehyde)siloxane), iii) bis-dimethyl(propyl-aldehyde)siloxy-terminated polymethyl(propyl-aldehyde)siloxane, iv) bis-trimethylsiloxy-terminated poly(dimethylsiloxane/methyl(propyl-aldehyde)siloxane), v) bis-trimethylsiloxy-terminated polymethyl(propyl-aldehyde)siloxane, vi) bis-dimethyl(propyl-aldehyde)siloxy-terminated poly(dimethylsiloxane/methylphenylsiloxane/methyl(propyl-aldehyde)siloxane), vii) bis-dimethyl(propyl-aldehyde)siloxy-terminated poly(dimethylsiloxane/methylphenylsiloxane), viii) bis-dimethyl(propyl-aldehyde)siloxy-terminated poly(dimethylsiloxane/diphenylsiloxane), ix) bis-phenyl,methyl(propyl-aldehyde)-siloxy-terminated polydimethylsiloxane, x) bis-dimethyl(heptyl-aldehyde)siloxy-terminated polydimethylsiloxane, xi) bis-dimethyl(heptyl-aldehyde)siloxy-terminated poly(dimethylsiloxane/methyl(heptyl-aldehyde)siloxane), xii) bis-dimethyl(heptyl-aldehyde)siloxy-terminated polymethyl(heptyl-aldehyde)siloxane, xiii) bis-trimethylsiloxy-terminated poly(dimethylsiloxane/methyl(heptyl-aldehyde)siloxane), xiv) bis-trimethylsiloxy-terminated polymethyl(heptyl-aldehyde)siloxane, xv) bis-dimethyl(heptyl-aldehyde)-siloxy terminated poly(dimethylsiloxane/methylphenylsiloxane/methyl(heptyl-aldehyde)siloxane), xvi) bis-dimethyl(propyl-aldehyde)siloxy-terminated poly(dimethylsiloxane/methyl(heptyl-aldehyde)siloxane), xvii) bis-dimethyl(heptyl-aldehyde)-siloxy-terminated poly(dimethylsiloxane/methylphenylsiloxane), xviii) dimethyl(heptyl-aldehyde)-siloxy-terminated poly(dimethylsiloxane/diphenylsiloxane), and xix) a combination of two or more of i) to xviii).

Alternatively, (E2) the aldehyde-functional polyorganosiloxane may be cyclic, e.g., when in unit formula (E2-1), subscripts a=b=c=e=f=g=h=0. The (E2-6) cyclic aldehyde-functional polydiorganosiloxane may have unit formula (E2-7): (R⁴R^{Ald}SiO_{2/2})_{d}, where R^{Ald} and R⁴ are as described above, and subscript d may be 3 to 12, alternatively 3 to 6, and alternatively 4 to 5. Examples of cyclic aldehyde-functional polydiorganosiloxanes include 2,4,6-trimethyl-2,4,6-tri(propyl-aldehyde)-cyclotrisiloxane, 2,4,6,8-tetramethyl-2,4,6,8-tetra(propyl-aldehyde)-cyclotetrasiloxane, 2,4,6,8,10-pentamethyl-2,4,6,8,10-penta(propyl-aldehyde)-cyclopentasiloxane, and 2,4,6,8,10,12-hexamethyl-2,4,6,8,10,12-hexa(propyl-aldehyde)-cyclohexasiloxane.

Alternatively, (E2-6) the cyclic aldehyde-functional polydiorganosiloxane may have unit formula (E2-8): (R⁴₂SiO_{2/2})_{c}(R⁴R^{Ald}SiO_{2/2})_{d}, where R⁴ and R^{Ald} are as described above, subscript c is >0 to 6 and subscript d is 3 to 12. Alternatively, in formula (E2-8), a quantity (c+d) may be 3 to 12. Alternatively, in formula (E2-8), c may be 3 to 6, and d may be 3 to 6.

Alternatively, (E2) the aldehyde-functional polyorganosiloxane may be (E2-9) oligomeric, e.g., when in unit formula (E2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (E2-6).

Examples of linear aldehyde-functional polyorganosiloxane oligomers may have formula (E2-10):

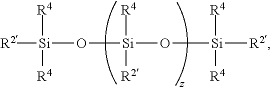

where R⁴ is as described above, each R^{2′} is independently selected from the group consisting of R⁴ and R^{Ald}, with the proviso that at least one R^{2′}, per molecule, is R^{Ald}, and subscript z is 0 to 48. Alternatively, subscript z may be 0 to 4; alternatively 0 to 1; and alternatively 0. Alternatively, when z=0 in formula (E2-10), the aldehyde-functional polyorganosiloxane oligomer may have formula (E2-10a):

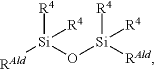

where R⁴ and R^{Ald} are as described above. Examples of linear aldehyde-functional polyorganosiloxane oligomers include 1,3-di(propyl-aldehyde)-1,1,3,3-tetramethyldisiloxane; 1,1,1,3,3-pentamethyl-3-(propyl-aldehyde)-disiloxane; and 1,1,1,3,5,5,5-heptamethyl-3-(propyl-aldehyde)-trisiloxane.

Alternatively, the aldehyde-functional polyorganosiloxane oligomer may be branched. The branched oligomer may have general formula (E2-11): R^{Ald}SiR¹²₃, where R^{Ald} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (E2-11) when each R¹² is R¹³, the branched polyorganosiloxane oligomer has the following structure (E2-11a):

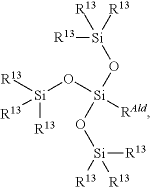

where R^{Ald} and R¹³ are as described above. Alternatively, in formula (E2-11a), each R^{Ald} may be propylaldehyde, butylaldehyde, or heptylaldehyde, and each R¹³ may be methyl.

Alternatively, in formula (E2-11) when each R¹² is —OSi(R¹⁴)₃, each R¹⁴ may be —OSi(R¹⁵)₃ moieties such that the branched polyorganosiloxane oligomer has the following structure (E2-11b):

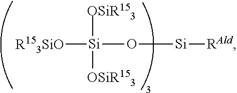

where R^{Ald} and R¹⁵ are as described above. Alternatively, each R¹⁵ may be an R¹³, as described above, and each R¹³ may be methyl.

Alternatively, in formula (E2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched aldehyde-functional polyorganosiloxane oligomer has the following structure (E2-11c):

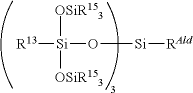

where R^{Ald}, R¹³, and R¹⁵ are as described above. Alternatively, each R¹⁵ may be an R¹³, and each R¹³ may be methyl.

Alternatively, in formula (E2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of are —OSiR¹³(R¹⁴)₂. Alternatively, each R¹⁴ in —OSiR¹³(R¹⁴)₂ may be —OSi(R⁵)₃ such that the branched polyorganosiloxane oligomer has the following structure (E2-11d):

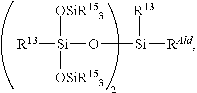

where R^{Ald}, R¹³, and R¹⁵ are as described above. Alternatively, each R¹⁵ may be an R¹³, and each R¹³ may be methyl. Alternatively, the aldehyde-functional branched polyorganosiloxane may have 3 to 16 silicon atoms per molecule, alternatively 4 to 16 silicon atoms per molecule, and alternatively 4 to 10 silicon atoms per molecule. Examples of aldehyde-functional branched polyorganosiloxane oligomers include 3-(3,3,3-trimethyl-1-λ²-disiloxaneyl)propanal (which can also be named propyl-aldehyde-tris(trimethyl)siloxy)silane), which has formula:

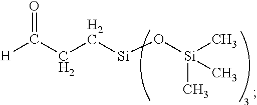

3-(1,3,5,5,5-pentamethyl-1λ³,3λ³-trisiloxaneyl)propanal (which can also be named methyl-(propyl-aldehyde)-di((1,1,1,3,5,5,5-heptamethyltrisiloxan-3-yl)oxy)-silane), which has formula

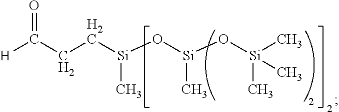

3-(3,5,5,5-tetramethyl-1λ²,3λ³-trisiloxaneyl)propanal (which can also be named (propyl-aldehyde)-tris((1,1,1,3,5,5,5-heptamethyltrisiloxan-3-yl)oxy)-silane), which has formula

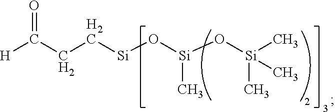

and
7-(3,5,5,5-tetramethyl-1λ²,3λ³-trisiloxaneyl)heptanal (which can also be named (heptyl-aldehyde)-tris((1,1,1,3,5,5,5-heptamethyltrisiloxan-3-yl)oxy)-silane), which has formula

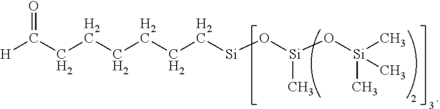

Alternatively, (E2) the aldehyde-functional polyorganosiloxane may be branched, such as the branched oligomer described above and/or a branched aldehyde-functional polyorganosiloxane that may have, e.g., more aldehyde groups per molecule and/or more polymer units than the branched oligomer described above (e.g., in formula (E2-1) when the quantity (a+b+c+d+e+f+g)>50). The branched aldehyde-functional polyorganosiloxane may have (in formula (E2-1)) a quantity (e+f+g) sufficient to provide >0 to 5 mol % of trifunctional and/or quadrifunctional units to the branched aldehyde-functional polyorganosiloxane.

For example, the branched aldehyde-functional polyorganosiloxane may comprise a Q branched polyorganosiloxane of unit formula (E2-13): (R⁴₃SiO_{1/2})_{q}(R⁴₂R^{Ald}SiO_{1/2})ᵣ(R⁴₂SiO_{2/2})ₛ(SiO_{4/2})ₜ, where R⁴ and R^{Ald} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa·s measured by rotational viscometry (as described below with the test methods) to the branched polyorganosiloxane. Alternatively, viscosity may be >170 mPa·s to 1000 mPa·s, alternatively >170 to 500 mPa·s, alternatively 180 mPa·s to 450 mPa·s, and alternatively 190 mPa·s to 420 mPa·s.

Alternatively, the branched aldehyde-functional polyorganosiloxane may comprise formula (E2-14): [R^{Ald}R⁴₂Si—(O—SiR⁴₂)ₓ—O]_{(4-w)}—Si—[O—(R⁴₂SiO)ᵥSiR⁴₃]_{w}, where R^{Ald} and R⁴ are as described above; and subscripts v, w, and x have values such that 200≥v≥1, 2≥w≥0, and 200≥x≥1. Alternatively, in this formula (E2-14), each R⁴ is independently selected from the group consisting of methyl and phenyl, and each R^{Ald} has the formula above, wherein G has 2, 3, or 6 carbon atoms.

Alternatively, the branched aldehyde-functional polyorganosiloxane for starting material (E2-11) may comprise a T branched polyorganosiloxane (silsesquioxane) of unit formula (E2-15): (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2})_{dd}, where R⁴ and R^{Ald} are as described above, subscript aa≥0, subscript bb≥0, subscript cc is 15 to 995, subscript dd>0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb>0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may b 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively ≤5≥dd≥0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (E2-15) with an aldehyde content of 0.1% to 1%, alternatively 0.2% to 0.6%, based on the weight of the silsesquioxane.

Alternatively, (E2) the aldehyde-functional polyorganosiloxane may comprise an aldehyde-functional polyorganosiloxane resin, such as an aldehyde-functional polyorganosilicate resin and/or an aldehyde-functional silsesquioxane resin. Such resins may be prepared, for example, by hydroformylating an alkenyl-functional polyorganosiloxane resin, as described above. The aldehyde-functional polyorganosilicate resin comprises monofunctional units (“M′” units) of formula R^{M′}₃SiO_{1/2} and tetrafunctional silicate units (“Q” units) of formula SiO_{4/2}, where each R^{M′} may be independently selected from the group consisting of R⁴ and R^{Ald} as described above. Alternatively, each R^{M′} may be selected from the group consisting of an alkyl group, an aldehyde-functional group of the formula shown above, and an aryl group. Alternatively, each R^{M′} may be selected from methyl, (propyl-aldehyde) and phenyl. Alternatively, at least one-third, alternatively at least two thirds of the R^{M′} groups are methyl groups. Alternatively, the M′ units may be exemplified by (Me₃SiO_{1/2}), (Me₂PhSiO_{1/2}), and (Me₂R^{Ald}SiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M′ and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M′}₃)₄, where R^{M′} is as described above, e.g., the neopentamer may be tetrakis(trimethylsiloxy)silane. ²⁹Si NMR and ¹³C NMR spectroscopies may be used to measure hydroxyl and alkoxy content and molar ratio of M′ and Q units, where said ratio is expressed as {M′(resin)}/{Q(resin)}, excluding M′ and Q units from the neopentamer. M′/Q ratio represents the molar ratio of the total number of triorganosiloxy groups (M′ units) of the resinous portion of the polyorganosilicate resin to the total number of silicate groups (Q units) in the resinous portion. M′/Q ratio may be 0.5/1 to 1.5/1, alternatively 0.6/1 to 0.9/1.

The Mn of the polyorganosilicate resin depends on various factors including the types of hydrocarbon groups represented by R^{M′} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively >3,000 Da to 8,000 Da. Alternatively, Mn of the polyorganosilicate resin may be 3,500 Da to 8,000 Da.

Alternatively, the polyorganosilicate resin may comprise unit formula (E2-17): (R⁴₃SiO_{1/2})ₘₘ(R⁴₂R^{Ald}SiO_{1/2})ₙₙ(SiO_{4/2})ₒₒ(ZO_{1/2})ₕ, where Z, R⁴, and R^{Ald}, and subscript h are as described above and subscripts mm, nn and oo have average values such that mm≥0, nn≥0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (E2) the aldehyde-functional polyorganosiloxane may comprise (E2-18) an aldehyde-functional silsesquioxane resin, i.e., a resin containing trifunctional (T′) units of unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(ZO_{1/2})ₕ; where R⁴ and R^{Ald} are as described above, subscript f>1, 2<(e+f)<10,000; 0<(a+b)/(e+f)<3; 0<(c+d)/(e+f)<3; and 0<h/(e+f)<1.5. Alternatively, the aldehyde-functional silsesquioxane resin may comprise unit formula (E2-19): (R⁴SiO_{3/2})ₑ(R^{Ald}SiO_{3/2})_{f}(ZO_{1/2})ₕ, where R⁴, R^{Ald}, Z, and subscripts h, e and f are as described above. Alternatively, the aldehyde-functional silsesquioxane resin may further comprise difunctional (D′) units of formulae (R⁴₂SiO_{2/2})_{c}(R⁴R^{Ald}SiO_{2/2})ₐ in addition to the T units described above, i.e., a D′T′ resin, where subscripts c and d are as described above. Alternatively, the aldehdye-functional silsesquioxane resin may further comprise monofunctional (M′) units of formulae (R⁴₃SiO_{1/2})ₐ(R⁴₂R^{Ald}SiO_{1/2})_{b}, i.e., an M′D′T′ resin, where subscripts a and b are as described above for unit formula (E2-1).

Alternatively, starting material (E) the aldehyde-functional organosilicon compound may comprise unit formula (E3-1): [(R¹_{(3-gg)}R^{Ald}_{gg}Si)_{ff}NH_{(3-ff)}]ₕₕ, where R^{Ald} is the aldehyde-group as described above; each R¹ is independently selected from the group consisting of an alkyl group and an aryl group as described above; each subscript ff is independently 1 or 2 as described above; subscript gg is independently 0, 1, or 2 as described above; and subscript h has a value such that 1<hh<10 as described above.

Starting material (E) may be any one of the aldehyde-functional organosilicon compounds described above (whether made via the hydroformylation reaction process described herein or some other method). Alternatively, starting material (E) may comprise a mixture of two or more of the aldehyde-functional organosilicon compounds.

Alternatively, in the process described herein starting material (E) may be a hydrolytically unstable aldehyde-functional organosilicon compound. The hydrolytically unstable aldehyde-functional organosilicon compound may be, for example, any one of (E1) the aldehyde-functional silanes and/or (E2) the aldehyde-functional polyorganosiloxanes of any of the formulas shown above, where at least one R⁴ is a hydrocarbonoxy group or an acyloxy group; any (E3) aldehyde-functional silazane; or any aldehyde-functional polyorganosiloxane oligomer of formula (E2-10a) such as 1,3-di(propyl-aldehyde)-1,1,3,3-tetramethyldisiloxane or (E2-11a) such as 1,1,1,5,5,5-hexamethyl-3-((trimethylsilyl)oxy)-3-vinyltrisiloxane, shown above.

### Preparing the Amino-Functional Organosilicon Compound

The process for preparing the amino-functional organosilicon compound may comprise:
I) combining, under conditions to effect a dehydrative imine generation reaction, starting materials comprising
   (E) the aldehyde-functional organosilicon compound described above, and
   (F1) a primary amine source;
   optionally (G) a hydrogenation catalyst; and
   optionally (J) a solvent;
   with the proviso that step I) is performed in the absence of hydrogen when (G) the hydrogenation catalyst is present in step I);
   thereby forming a reaction product comprising (L) an imine-functional organosilicon compound and water;
optionally II) removing the water generated by the dehydrative imine generation reaction in step I); and
optionally isolating (L) the propylimine-functional organosilicon compound. The propylimine-functional organosilicon compound may be isolated by any convenient means such as stripping and/or distillation of the reaction product, and the propylimine-functional organosilicon compound may be used for other purposes than those described below. Alternatively, (L) the propylimine-functional organosilicon compound may be used to prepare the aminopropyl-functional organosilicon compound when the process further comprises:
III) combining, under conditions to catalyze reductive amination reaction, starting materials comprising
   (L) the imine-functional organosilicon compound described above,
   (F2) ammonia,
   optionally (G) a hydrogenation catalyst,
   (H) hydrogen, and
   optionally (J) a solvent; thereby forming a reductive amination reaction product comprising the amino-functional organosilicon compound.
   with the proviso that (G) the hydrogenation catalyst is added in at least one of step I) and step III).

The process may optionally further comprise, before step I), 1) combining, under conditions to catalyze hydroformylation reaction, starting materials comprising (A) the gas comprising hydrogen and carbon monoxide, (B) the alkenyl-functional organosilicon compound, and (C) the rhodium/bisphosphite ligand complex catalyst, thereby forming a hydroformylation reaction product comprising the aldehyde-functional organosilicon compound as described above. The process may optionally further comprise, before step I) and after step 1), step 2) recovering (C) the rhodium/bisphosphite ligand complex catalyst from the reaction product comprising the aldehyde-functional organosilicon compound. However, step 2) is optional and may be unnecessary. For example, when hydroformylation is used to prepare (E) the aldehyde-functional organosilicon compound, the hydroformylation reaction catalyst may be unnecessary to remove because, without wishing to be bound by theory, it is thought that the amount of catalyst is not cost effective to remove and/or the selection and amount of catalyst do not detrimentally impact the dehydrative imine generation reaction or the reductive amination reaction. The process may optionally further comprise, before step I) and after step 1) or step 2) (when present), step 3) purifying the hydroformylation reaction product; thereby isolating (E) the aldehyde-functional organosilicon compound from the additional materials, as described above. However, this step 3) is optional, and may be unnecessary, for example, when a solvent is used for hydroformylation reaction to prepare (E) the aldehyde-functional organosilicon compound, and the same solvent will be used in a step later in the process.

### Step I) Protecting the Aldehyde

In step I) of the process described above, a dehydrative imine generation reaction occurs to protect the aldehyde group and form an imine group. In step I), starting materials comprising (E) the aldehyde-functional organosilicon compound and (F1) a primary amine source may be combined by any convenient means, such as mixing. Mixing may be performed by any convenient means, at e.g., RT and ambient pressure and atmosphere. Time for mixing is sufficient for an imine group to form from the aldehyde group under the conditions selected. Step I) may be performed in a batch mode or a continuous mode. Time is not critical and is sufficient for the imine group to form, such as 1 second to 1 hour.

### (F) Amine Sources

In the process described herein, (F1) a primary amine source is used in step I). The primary amine source may be any primary amine source that is inexpensive and separable from the amino-functional organosilicon compound to be prepared by the process. The primary amine source may be an organic primary amine. The organic primary amine may have formula: R¹⁸NH₂, where R¹⁸ is an alkyl group of 1 to 18 carbon atoms or an aryl group of 6 to 18 carbon atoms. Suitable alkyl groups for R¹⁸ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Suitable aryl groups for R¹⁸ may be, for example, phenyl, tolyl, xylyl, phenyl ethyl, and benzyl. Alternatively, the alkyl group for R¹⁸ may be selected from the group consisting of ethyl, propyl and butyl; alternatively ethyl and propyl; alternatively propyl and butyl. Alternatively, the alkyl group for R¹⁸ may be propyl. Alternatively, R¹⁸ may be an aryl group, and alternatively R¹⁸ may be benzyl. Alternatively, the organic primary amine may have more than one primary amine group per molecule. Organic primary amines are known in the art and are commercially available. For example, ethyl amine, propyl amine, n-butyl amine, isobutyl amine, and benzyl amine are available from various sources, such as Acros Organics or Sigma Aldrich, Inc. of St. Louis, Missouri, USA. Alternatively, the primary amine source may comprise a primary amino-functional organosilicon compound. The primary amino-functional organosilicon compound used as the primary amine source in step I) may be any primary amino-functional organosilicon compound, e.g., the primary amine source may have the same formula as primary amino-functional organosilicon compound to be prepared by this process. For example, the primary amine source may be 2-aminopropyltrimethylsilane, 3,3′-(1,1,3,3-tetramethyldisiloxane-1,3-diyl)propan-diamine. The formation of an imine-functional organosilicon compound using a primary amino-functional organosilicon compound as the primary amine source is illustrated below in Scheme 1.

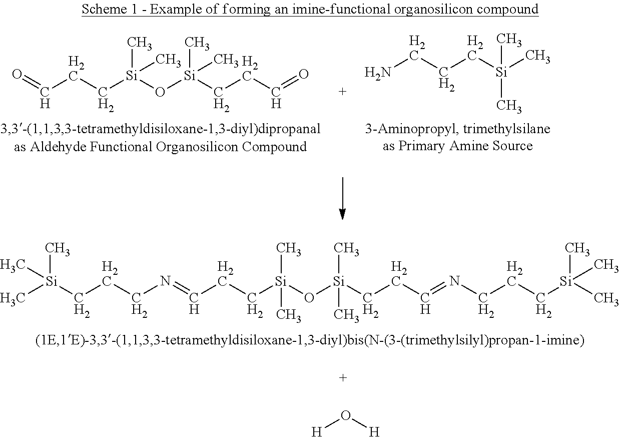

The primary amine source used in step I) may be used in a superstoichiometric amount of amine functionality with respect to the aldehyde-functionality of (E) the aldehyde-functional organosilicon compound. For example, the primary amine source may be used in an amount sufficient to provide 10:1 to 1:1 molar ratio of amine groups:aldehyde groups.

### Imine-Functional Organosilicon Compound

The imine-functional organosilicon compound prepared in step I) of the process described above has, per molecule, at least one imine-functional group covalently bonded to silicon. Alternatively, the imine-functional organosilicon compound may have, per molecule, more than one imine-functional group covalently bonded to silicon. This imine-functional group, R¹, may have formula:

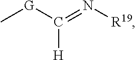

where G is a divalent hydrocarbon group free of aliphatic unsaturation that has 2 to 8 carbon atoms as described and exemplified above, and R¹⁹ is selected from R¹⁸ (the alkyl group or the aryl group as described above when the organic primary amine is used as the primary amine source) and an organosilicon moiety (when the amino-functional organosilicon compound is used as the primary amine source). The imine-functional organosilicon compound may have any of the formulas described above for (E) the aldehyde-functional organosilicon compound, with the proviso that at least one R^{AW} per molecule is replaced with R¹. Alternatively, all, or substantially all, instances of R^{Ald} may be replaced with R¹.

The imine-functional organosilicon compound may comprise (L1) an imine-functional silane of formula (L1-1): R¹ₓSiR⁴₍₄₋ₓ₎, where R¹, R⁴ and subscript x are as described above.

Alternatively, the imine-functional organosilicon compound may comprise (L2) an imine-functional polyorganosiloxane. Said imine-functional polyorganosiloxane may be cyclic, linear, branched, resinous, or a combination of two or more thereof. Said imine-functional polyorganosiloxane may comprise unit formula (L2-1): (R⁴₃SiO_{1/2})ₐ(R⁴₂R¹SiO_{1/2})_{b}(R⁴₂SiO_{2/2})_{c}(R⁴R¹SiO_{2/2})_{d}(R⁴SiO_{3/2})ₑ(R¹SiO_{3/2})_{f}(SiO_{4/2})_{g}(ZO_{1/2})ₕ; where each R¹ is an independently selected imine group of the formula described above, and R⁴, Z, and subscripts a, b, c, d, e, f, g, and h are as described above for formula (B2-1).

Alternatively, (L2) the imine-functional polyorganosiloxane may comprise (L2-2) a linear polydiorganosiloxane having, per molecule, at least one imine-functional group; alternatively at least two imine-functional groups (e.g., when in the formula (L2-1) for the imine-functional polyorganosiloxane above, subscripts e=f=g=0). For example, said polydiorganosiloxane may comprise unit formula (L2-3): (R⁴₃SiO_{1/2})ₐ(R¹R⁴₂SiO_{1/2})_{b}(R⁴₂SiO_{2/2})_{c}(R¹R⁴SiO_{2/2})ₐ, where R¹ is as described above, and R⁴ and are subscripts a, b, c, and d are as described above for formula (E2-3).

Alternatively, the linear imine-functional polydiorganosiloxane of unit formula (L2-3) may be selected from the group consisting of: unit formula (L2-4): (R⁴₂R¹SiO_{1/2})₂(R⁴₂SiO_{2/2})ₘ(R⁴R¹SiO_{2/2})ₙ, unit formula (L2-5): (R⁴₃SiO_{1/2})₂(R⁴₂SiO_{2/2})ₒ(R⁴R¹SiO_{2/2})ₚ, or a combination of both (L2-4) and (L2-5).

In formulae (L2-4) and (L2-5), R¹ is as described above, and R⁴ and subscripts m, n, o, and p are as described above for formulae (E2-4) and (E2-5).

Alternatively, (L2) the imine-functional polyorganosiloxane may be cyclic, e.g., when in unit formula (L2-1), subscripts a=b=c=e=f=g=h=0. The (L2-6) cyclic imine-functional polydiorganosiloxane may have unit formula (L2-7): (R⁴R¹SiO_{2/2})_{d}, where R¹ and R⁴ are as described above, and subscript d may be 3 to 12, alternatively 3 to 6, and alternatively 4 to 5.

Alternatively, (L2-6) the cyclic imine-functional polydiorganosiloxane may have unit formula (L2-8): (R⁴₂SiO_{2/2})_{c}(R⁴R¹SiO_{2/2})_{d}, where R⁴ and R¹ are as described above, subscript c is >0 to 6 and subscript d is 3 to 12. Alternatively, in formula (L2-8), a quantity (c+d) may be 3 to 12. Alternatively, in formula (L2-8), c may be 3 to 6, and d may be 3 to 6.

Alternatively, (L2) the imine-functional polyorganosiloxane may be (L2-9) oligomeric, e.g., when in unit formula (L2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (L2-6).

Examples of linear imine-functional polyorganosiloxane oligomers may have formula (L2-10):

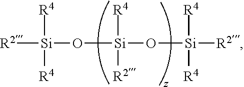

where R⁴ is as described above, each R^{2′} is independently selected from the group consisting of R⁴ and R¹, with the proviso that at least one R^{2′″}, per molecule, is R¹, and subscript z is 0 to 48. Alternatively, subscript z may be 0 to 4; alternatively 0 to 1; and alternatively 0. Alternatively, when z=0 in formula (L2-10), the imine-functional polyorganosiloxane oligomer may have formula (L2-10a):

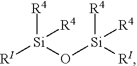

where R⁴ and R¹ are as described above.

Alternatively, the imine-functional polyorganosiloxane oligomer may be branched. The branched oligomer may have general formula (L2-11): R¹SiR¹²₃, where R¹ is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³2]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (L2-11) when each R¹² is R¹³, the branched polyorganosiloxane oligomer has the following structure (L2-11a):

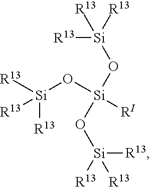

where R¹ and R¹³ are as described above. Alternatively, in formula (L2-11a) each R¹³ may be methyl.

Alternatively, in formula (L2-11) when each R¹² is —OSi(R¹⁴)₃, each R¹⁴ may be —OSi(R¹⁵)₃ moieties such that the branched polyorganosiloxane oligomer has the following structure (L2-11b):

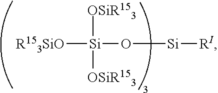

where R¹ and R⁵ are as described above. Alternatively, each R¹⁵ may be an R¹³, as described above, and each R¹³ may be methyl.

Alternatively, in formula (L2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴) may each be —OSi(R¹⁵)₃ moieties such that the branched polyorganosiloxane oligomer has the following structure (L2-11c):

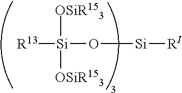

where R¹, R¹³, and R¹⁵ are as described above. Alternatively, each R¹⁵ may be an R¹³, and each R¹³ may be methyl.

Alternatively, in formula (L2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of are —OSiR¹³(R¹⁴)₂. Alternatively, each R¹⁴ in —OSiR¹³(R¹⁴)₂ may be —OSi(R⁵)₃ such that the branched polyorganosiloxane oligomer has the following structure (L2-11d):

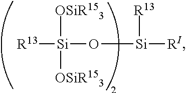

where R¹, R¹³, and R¹⁵ are as described above. Alternatively, each R¹⁵ may be an R¹³, and each R¹³ may be methyl. Alternatively, the branched polyorganosiloxane may have 3 to 16 silicon atoms per molecule, alternatively 4 to 16 silicon atoms per molecule, and alternatively 4 to 10 silicon atoms per molecule. Examples of imine-functional branched polyorganosiloxane oligomers include (E)-N-butyl-3-(1,1,1,5,5,5-hexamethyl-3-((trimethylsilyl)oxy)trisiloxan-3-yl)propan-1-imine, which has formula:

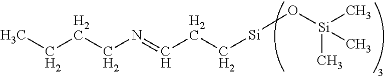

and
(E)-3-(1,1,1,5,5,5-hexamethyl-3-((trimethylsilyl)oxy)trisiloxan-3-yl)-N-propylpropan-1-imine, which has formula

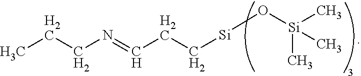

Alternatively, (L2) the imine-functional polyorganosiloxane may be branched, such as the branched oligomer described above and/or a branched imine-functional polyorganosiloxane that may have, e.g., more imine groups per molecule and/or more polymer units than the branched oligomer described above (e.g., in formula (L2-1) when the quantity (a+b+c+d+e+f+g)>50). The branched imine-functional polyorganosiloxane may have (in formula (L2-1)) a quantity (e+f+g) sufficient to provide >0 to 5 mol % of trifunctional and/or quadrifunctional units to the branched imine-functional polyorganosiloxane.

For example, the branched imine-functional polyorganosiloxane may comprise a Q branched polyorganosiloxane of unit formula (L2-13): (R⁴₃SiO_{1/2})_{q}(R⁴₂R¹SiO_{1/2})ᵣ(R⁴₂SiO_{2/2})ₛ(SiO_{4/2})ₜ, where R¹ is as described above, and R⁴ and subscripts q, r, s, and t are as described above for (E2-13).

Alternatively, the branched imine-functional polyorganosiloxane may comprise formula (L2-14): [R¹R⁴₂Si—(O—SiR⁴₂)ₓ—O]_{(4-w)}—Si—[O—(R⁴₂SiO)ᵥSiR⁴₃]_{w}, where R¹ is as described above, and R⁴ and subscripts v, w, and x are as described above with respect to formula (E2-14). Alternatively, in this formula (L2-14), each R⁴ is independently selected from the group consisting of methyl and phenyl, and each R¹ has the formula above, wherein G has 2, 3, or 6 carbon atoms.

Alternatively, the branched imine-functional polyorganosiloxane for (L2-11) may comprise a T branched polyorganosiloxane (silsesquioxane) of unit formula (L2-15): (R⁴₃SiO_{1/2})ₐₐ(R¹R⁴₂SiO_{1/2})_{bb}(R⁴₂SiO_{2/2})_{cc}(R⁴SiO_{2/2})ₑₑ(R⁴SiO_{3/2})ₐₐ, where R¹ is as described above, and R⁴ and subscripts aa, bb, cc, dd, and ee are as described above for unit formula (E2-15).

Alternatively, (L2) the imine-functional polyorganosiloxane may comprise an imine-functional polyorganosiloxane resin, such as an imine-functional polyorganosilicate resin and/or an imine-functional silsesquioxane resin. The imine-functional polyorganosilicate resin comprises monofunctional units (“M″″” units) of formula R^{M″″}₃SiO_{1/2} and tetrafunctional silicate units (“Q” units) of formula SiO_{4/2}, where each R^{M″″} may be independently selected from the group consisting of R⁴ and R¹ as described above. Alternatively, each R^{M″″} may be selected from the group consisting of an alkyl group, an imine-functional group of the formula for R¹ shown above, and an aryl group. Alternatively, the M′″ units may be exemplified by (Me₃SiO_{1/2}), (Me₂PhSiO_{1/2}), and (Me₂R¹SiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

The imine-functional polyorganosilicate resin comprises the M′″ and Q units described above, and the polyorganosilicate resin further comprises units with silicon bonded hydroxyl groups, and/or hydrolyzable groups, described by moiety (ZO_{1/2}), above, and may comprise neopentamer of formula Si(OSiR^{M′″}₃)₄, where R^{M′″} is as described above, e.g., the neopentamer may be tetrakis(trimethylsiloxy)silane. ²⁹Si NMR and ¹³C NMR spectroscopies may be used to measure hydroxyl and alkoxy content and molar ratio of M′″ and Q units, where said ratio is expressed as {M′″(resin)}/{Q(resin)}, excluding M′″ and Q units from the neopentamer. M′″/Q ratio represents the molar ratio of the total number of triorganosiloxy groups (M′″ units) of the resinous portion of the polyorganosilicate resin to the total number of silicate groups (Q units) in the resinous portion. M′″/Q ratio may be 0.5/1 to 1.5/1, alternatively 0.6/1 to 0.9/1.

The Mn of the polyorganosilicate resin depends on various factors including the types of hydrocarbon groups represented by R^{M′″} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively >3,000 Da to 8,000 Da. Alternatively, Mn of the polyorganosilicate resin may be 3,500 Da to 8,000 Da.

Alternatively, the polyorganosilicate resin may comprise unit formula (L2-17): (R⁴₃SiO_{1/2})ₘₘ(R⁴₂R¹SiO_{1/2})ₙₙ(SiO_{4/2})ₒₒ(ZO₁/2)ₕ, where Z, R⁴, and R¹, and subscript h are as described above and subscripts mm, nn and oo have average values such that mm≥0, nn≥0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (L2) the imine-functional polyorganosiloxane may comprise (L2-18) an imine-functional silsesquioxane resin, i.e., a resin containing trifunctional (T′″) units of unit formula: (R⁴₃SiO_{1/2})ₐ(R⁴₂R¹SiO_{1/2})_{b}(R⁴₂SiO_{2/2})_{c}(R⁴R¹SiO_{2/2})_{d}(R⁴SiO_{3/2})ₑ(R¹SiO_{3/2})(ZO_{1/2})ₕ; where R⁴ and R¹ are as described above, subscript f>1, 2<(e+f)<10,000; 0<(a+b)/(e+f)<3; 0<(c+d)/(e+f)<3; and 0<h/(e+f)<1.5. Alternatively, the imine-functional silsesquioxane resin may comprise unit formula (L2-19): (R⁴SiO_{3/2})ₑ(R¹SiO_{3/2})_{f}(ZO_{1/2})ₕ, where R⁴, R¹, Z, and subscripts h, e and f are as described above. Alternatively, the imine-functional silsesquioxane resin may further comprise difunctional (D′″) units and said imine-functional silsesquioxane resin may comprise units of formulae (R⁴₂SiO_{2/2})_{c}(R⁴R¹SiO_{2/2})_{d} in addition to the T units described above, i.e., a D′″T′″ resin, where subscripts c and d are as described above. Alternatively, the imine-functional silsesquioxane resin may further comprise monofunctional (M′″) units of formulae (R⁴₃SiO_{1/2})ₐ(R⁴₂R¹SiO_{1/2})_{b}, i.e., an M′″D′″T′″ resin, where subscripts a and b are as described above for unit formula (E2-1).

Alternatively, (L) the imine-functional organosilicon compound may comprise unit formula (L3-1): [(R¹_{(3-gg)}R¹_{gg}Si)_{ff}NH_{(3-ff)}]ₕₕ, where R¹ is the imine-group as described above; each R¹ is independently selected from the group consisting of an alkyl group and an aryl group as described above; each subscript ff is independently 1 or 2 as described above; subscript gg is independently 0, 1, or 2 as described above; and subscript h has a value such that 1<hh<10 as described above.

The imine-functional organosilicon compound, (L) prepared in step I), and which can be used in step III) of the process described herein may be any one of the imine-functional organosilicon compounds described above. Alternatively, (L) the imine-functional organosilicon compound may comprise a mixture of two or more of the imine-functional organosilicon compounds.

Alternatively, in the process described herein (L) the imine-functional organosilicon compound may be a hydrolytically unstable imine-functional organosilicon compound. The hydrolytically unstable imine-functional organosilicon compound may be, for example, any one of (L1) the imine-functional silanes and/or (L2) the imine-functional polyorganosiloxanes of any of the formulas shown above, where at least one R⁴ is a hydrocarbonoxy group or an acyloxy group; any (L3) imine-functional silazane; or any imine-functional polyorganosiloxane oligomer of formula (L2-10a) or (L2-11a) such as (E)-N-butyl-3-(1,1,1,5,5,5-hexamethyl-3-((trimethylsilyl)oxy)trisiloxan-3-yl)propan-1-imine or (E)-3-(1,1,1,5,5,5-hexamethyl-3-((trimethylsilyl)oxy)trisiloxan-3-yl)-N-propylpropan-1-imine, shown above.

### Step II) Drying

The process described above may optionally further comprise step II) removing water generated by the dehydrative imine generation reaction in step I). Step II) may be performed during and/or after step I); during and/or after step III), or a combination thereof. Alternatively, step II) may be present and performed during and/or after step I), e.g., when a hydrolytically unstable aldehyde-functional organosilicon compound is used and/or a hydrolytically unstable imine-functional organosilicon compound or hydrolytically unstable amino-functional organosilicon compound will be formed during the process.

In step II), water may be removed by any convenient means, such as stripping, distillation, and/or contacting the reaction mixture in step I) and/or the reaction product of step I) with (K) a drying agent. The drying agent may comprise an adsorbent, which may comprise an inorganic particulate. The adsorbent may have a particle size of 10 micrometers or less, alternatively 5 micrometers or less. The adsorbent may have average pore size sufficient to adsorb water, for example 10 Å (Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof.

Examples of commercially available adsorbents include dry molecular sieves, such as 3 Å (Angstrom) molecular sieves, which are commercially available from Grace Davidson under the trademark SYLOSIV™ and from Zeochem of Louisville, Kentucky, U.S.A. under the trade name PURMOL, and 4 Å molecular sieves such as Doucil zeolite 4A available from Ineos Silicas of Warrington, England. Other useful molecular sieves include MOLSIV ADSORBENT TYPE 13X, 3A, 4A, and 5A, all of which are commercially available from UOP of Illinois, U.S.A.; SILIPORITE NK 30AP and 65xP from Atofina of Philadelphia, Pennsylvania, U.S.A.; and molecular sieves available from W.R. Grace of Maryland, U.S.A.

Alternatively, the drying agent may comprise a chemical that complexes with water, such as calcium chloride (CaCl₂)), sodium sulfate (Na₂SO₄) calcium sulfate (CaSO₄), or magnesium sulfate (MgSO₄), all of which are commercially available.

The amount of the drying agent is not specifically restricted and depends on various factors including the type of the drying agent selected. One skilled in the art would be able to select an appropriate drying agent and conditions for removing water in step II). When the drying agent is used, the process described herein may further comprise removing the drying agent before step III). The drying agent may then be removed by any convenient means, such as filtration. Alternatively, the drying agent may be used during and/or after step III). The drying agent may then be removed after step III).

The process for making the amino-functional organosilicon compound may optionally further comprise, before step III), an additional step of pre-treating (G) the hydrogenation catalyst. Pre-treating may be performed to activate the catalyst and/or increase the activity of the catalyst. Pre-treating may be performed by any convenient means, such as exposing the hydrogenation catalyst to hydrogen before beginning the reductive amination reaction in step III). For example, a packed bed of hydrogenation catalyst may be purged with hydrogen before introducing (L) the imine-functional organosilicon compound and (F2) the ammonia.

In step III) of the process, (F2) ammonia, which has formula NH₃, e.g., anhydrous ammonia is used. Ammonia is known in the art and commercially available from various sources, including Air Products of Allentown, Pennsylvania, USA. The amount of (F2) ammonia used in step III) may be sufficient to provide a >1:1, alternatively >5:1, alternatively 10:1 to 40:1 molar ratio of ammonia: imine groups.

### (G) Hydrogenation Catalyst

The hydrogenation catalyst used in step III) of the process for preparing the amino-functional organosilicon compound may be a heterogeneous hydrogenation catalyst, a homogenous hydrogenation catalyst, or a combination thereof. Alternatively, the hydrogenation catalyst may be a heterogeneous hydrogenation catalyst. Suitable heterogeneous hydrogenation catalysts comprise a metal selected from the group consisting of cobalt (Co), copper (Cu), iron (Fe), nickel (Ni), iridium (Ir), palladium (Pd), platinum (Pt), rhodium (Rh), ruthenium (Ru), and a combination of two or more thereof. Alternatively, the hydrogenation catalyst may comprise Co, Cu, Ni, Pd, Pt, Ru, or a combination of two or more thereof. Alternatively, the hydrogenation catalyst may comprise Co, Cu, Ni, Pd, or a combination of two or more thereof. Alternatively, the hydrogenation catalyst may comprise Co, Cu, Ni, or a combination of two or more thereof. The hydrogenation catalyst may include a support, such as alumina (Al₂O₃), silica (SiO₂), silicon carbide (SiC), or carbon (C). Alternatively, the hydrogenation catalyst may be selected from the group consisting of Rh/C, Raney nickel, Raney copper, Raney cobalt, Ru/C, Ru/Al₂O₃, Pd/C, Pd/Al₂O₃, Pd/CaCO₃, Cu/C, Cu/Al₂O₃, Cu/SiO₂, Cu/SiC, Cu/C, a nickel catalyst on a support described above, and a combination of two or more thereof.

Alternatively, heterogeneous hydrogenation catalysts for reductive amination of the imine group of (L) the imine-functional organosilicon compound may include a support material on which copper, chromium, nickel, rhodium, or two or more thereof are applied as active components. Exemplary catalysts include copper at 0.3 to 15%; nickel at 0.3% to 15%, and chromium at 0.05% to 3.5%. The support material may be, for example, porous silicon dioxide or aluminium oxide. Barium may optionally be added to the support material. Chromium free hydrogenation catalysts may alternatively be used. For example a Ni/Al₂O₃ or Co/Al₂O₃ may be used, or a copper oxide/zinc oxide containing catalyst, which further comprises potassium, nickel, and/or cobalt; and additionally an alkali metal. Suitable hydrogenation catalysts are disclosed for example, in U.S. Pat. No. 7,524,997 or U.S. Pat. No. 9,567,276 and the references cited therein. Alternatively, heterogeneous hydrogenation catalysts may be commercially available, such as Rh/C catalyst, which is available from Sigma-Aldrich; Ni-5256P, which is available from BASF; and Co-179, which is also commercially available.

Other examples of suitable heterogeneous hydrogenation catalysts for use herein include Raney Nickel such as Raney Nickel 2400, Ni-3288, Raney Copper, Hysat 401 salt (Cu), ruthenium on carbon (Ru/C), rhodium on carbon (Rh/C), platinum on carbon (Pt/C), copper on silicon carbide (Cu/SiC).

Alternatively, a homogeneous hydrogenation reaction catalyst may be used herein. The homogeneous hydrogenation catalyst may be a metal complex, where the metal may be selected from the group consisting of Co, Fe, Ir, Rh, and Ru. Examples of suitable homogeneous hydrogenation catalysts are exemplified by [RhCl(PPh₃)₃] (Wilkinson's catalyst); [Rh(NBD)(PR′₃)₂]+ClO₄- (where R′ is an alkyl group, e.g. Et); [RuCl₂(diphosphine)(1,2-diamine)] (Noyori catalysts); RuCl₂(TRIPHOS) (where TRIPHOS=PhP[(CH₂CH₂PPh₂)₂]; Ru(II)(dppp)(glycine) complexes (where dppp=1,3-bis(diphenylphosphino)propane); RuCl₂(PPh₃)₃; RuCl₂(CO)₂(PPh₃)₂; IrH₃(PPh₃)₃; [Ir(H₂)(CH₃COO)(PPh₃)₃]; cis-[Ru—Cl2(ampy)(PP)] [where ampy=2-(aminomethyl)pyridine; and PP=1,4-bis-(diphenylphosphino)butane, 1,1′-ferrocenediyl-bis(diphenylphosphine)]; Pincer RuCl(CNNR)(PP) complexes [where PP=1,3-bis(diphenylphosphino)propane, 1,4-bis(diphenylphosphino)butane, 1,1′-ferrocenediyl-bis(diphenylphosphine); and HCNNR=4-substituted-aminomethyl-benzo[h]quinoline; R=Me, Ph]; [RuCl₂(dppb)(ampy)] (where dppb=1,4-Bis(diphenylphosphino)butane, ampy=2-aminomethyl pyridine); [Fe(PNPMeiPr)(CO)(H)(Br)]; [Fe(PNPMe-iPr)(H)₂(CO)]; and a combination thereof.

The amount of hydrogenation catalyst used in the process depends on various factors including whether the process will be run in a batch or continuous mode, the type of imine-functional organosilicon compound, whether a heterogeneous or homogeneous hydrogenation catalyst is selected, and reductive amination reaction conditions such as temperature and pressure. However, when the process is run in a batch mode the amount of catalyst may be <1 weight % to 50 weight %, alternatively 5 weight % to 30 weight %, based on weight of the imine-functional organosilicon compound. Alternatively, the amount of catalyst may be at least 1, alternatively at least 4, alternatively at least 6.5, and alternatively at least 8, weight %; while at the same time the amount of catalyst may be up to 50, alternatively up to 20, alternatively up to 14, alternatively up to 13, alternatively up to 10, and alternatively up to 9, weight %, on the same basis. Alternatively, when the process will be run in a continuous mode, e.g., by packing a reactor with a heterogeneous hydrogenation catalyst, the amount of the heterogeneous hydrogenation catalyst may be sufficient to provide a reactor volume (filled with hydrogenation catalyst) to achieve a space time of 10 hr⁻¹, or catalyst surface area sufficient to achieve 10 kg/hr substrate per m² of catalyst.

### (H) Hydrogen

Hydrogen is known in the art and commercially available from various sources, e.g., Air Products. Hydrogen may be used in a superstoichiometric amount with respect to the imine group of (L) the imine-functional organosilicon compound to permit complete reaction.

### (J) Solvent

A solvent, (J), that may optionally be used in the process for preparing the imine-functional organosilicon compound and/or the amino-functional organosilicon compound may be selected from those solvents that are neutral to the dehydrative imine generation reaction, when used in step I) described above and/or the reductive amination reaction when used in step III) of the process. The following are specific examples of such solvents: monohydric alcohols such as methanol, ethanol, and isopropyl alcohol; dioxane, ethers such as THF; aliphatic hydrocarbons, such as hexane, heptane, and paraffinic solvents; and aromatic hydrocarbons such as benzene, toluene, and xylene; and chlorinated hydrocarbons. These solvents can be used individually or in combinations of two or more. The amount of solvent is not critical and may depend on various factors such as the type and amount of each starting material to be used. For example, more solvent may be used when the aldehyde-functional organosilicon compound and/or the imine-functional organosilicon is resinous as opposed to oligomeric. However, the amount of solvent may be 0 to 99% based on combined weights of all starting materials used in the process.

During or after step III) of the process, removing water as described above for step II) may be performed. For example, (K) a drying agent such as an adsorbent or water complexing agent may optionally be used to remove water generated as a side product. Suitable drying agents and conditions for their use are as described above. The drying agent selected for use during or after step III) may be the same as, or different from, the drying agent selected for use during or after step I). Alternatively, if a drying agent is used during or after step I), a drying agent may be omitted during or after step III).

### Step III) Reductive Amination Reaction

The reductive amination reaction in step III) can be performed using pressurized hydrogen. Hydrogen (gauge) pressure may be 10 psig (68.9 kPa) to 3000 psig (20,685 kPa), alternatively 10 psig to 2000 psig (13,790 kPa), alternatively 10 psig to 1500 psig (10,342 kPa), alternatively 200 psig (1379 kPa) to 1200 psig (8274 kPa). The reaction may be carried out at a temperature of 0 to 200° C. Alternatively, a temperature of 50 to 150° C. may be suitable for shortening the reaction time. Alternatively, the hydrogen (gauge) pressure used may be at least 25, alternatively at least 50, alternatively at least 100, alternatively at least 150, and alternatively at least 164, psig; while at the same time the hydrogen gauge pressure may be up to 800, alternatively up to 400, alternatively up to 300, alternatively up to 200, and alternatively up to 194, psig. The temperature for reaction may be at least 40, alternatively at least 50, alternatively at least 65, alternatively at least 80, ° C., while at the same time the temperature may be up to 200, alternatively up to 150, alternatively up to 120, ° C.

The reductive amination reaction can be carried out in a batch mode or a continuous mode. In a batch mode, the reductive amination reaction time depends on various factors including the amount of the catalyst and reductive amination reaction temperatures, however, step III) of the process for preparing the amino-functional organosilicon compound may be performed for 1 minute to 24 hours. Alternatively, the reductive amination reaction may be performed for at least 1 minute, alternatively at least 2 minutes, alternatively at least 1 hour, alternatively at least 2 hours, alternatively at least 3 hours, alternatively at least 3.3 hours, alternatively at least 3.7 hours, alternatively at least 4 hours, alternatively at least 4.5 hours, alternatively at least 5.5 hours, and alternatively at least 6 hours; while at the same time, the reductive amination reaction may be performed for up to 24 hours, alternatively up to 23 hours, alternatively up to 22.5 hours, alternatively up to 22 hours, alternatively up to 17.5 hours, alternatively up to 17 hours, and alternatively up to 16.5 hours.

Alternatively, in a batch mode, the terminal point of a reductive amination reaction can be considered to be the time during which the decrease in reactor pressure is no longer observed after the reaction is continued for an additional 1 to 2 hours. If reactor pressure decreases in the course of the reaction, it may be desirable to repeat the introduction of hydrogen and ammonia, and to maintain it under increased pressure to shorten the reaction time. Alternatively, the reactor can be re-pressurized with hydrogen and the ammonia 1 or more times to achieve sufficient supply of hydrogen and amine source for reaction of the imine functionality while maintaining reasonable reactor pressures.

In a continuous mode, reductive amination reaction may be performed in a trickle bed reactor. The trickle bed reactor may provide reduced capital expenditure and/or increased yield in step III) of the process, and/or easier processing for separation of the amino-functional organosilicon compound from the catalyst after step III) of the process. Alternatively, a high pressure reactor (e.g., a reactor capable of withstanding pressures up to 3000 psig (20,685 kPa), as described above, may be used for reductive amination reaction in step III) in either a batch or continuous mode.

After completion of the reductive amination reaction, (G) the hydrogenation catalyst may be separated in a pressurized inert (e.g., nitrogenous) atmosphere by any convenient means, such as filtration or adsorption, e.g., with diatomaceous earth or activated carbon, settling, centrifugation, by maintaining the hydrogenation catalyst in a structured packing or other fixed structure, or a combination thereof.

The reductive amination reaction in step III) may also produce a by-product comprising the primary amine source (as described above for use in step I)). The primary amine source may be recovered from the reductive amination reaction product produced in step III) by any convenient means, such as stripping and/or distillation. The resulting primary amine source so recovered may be recycled into the process in step I). An exemplary reaction scheme illustrating the process described above is described and shown below.

### Exemplary Reaction Scheme

In an optional first step, an alkenyl-functional organosilicon compound (e.g., 1,1,1,5,5,5-hexamethyl-3-((trimethylsilyl)oxy)-3-vinyltrisiloxane) is undergoes hydroformylation reaction to form an aldehyde-functional organosilicon compound (e.g., 3-(1,1,1,5,5,5-hexamethyl-3-((trimethylsilyl)oxy)trisiloxan-3-yl)propanal). In step I), the aldehyde-functional organosilicon compound (e.g., 3-(1,1,1,5,5,5-hexamethyl-3-((trimethylsilyl)oxy)trisiloxan-3-yl)propanal) is combined with an organic primary amine (e.g., N-butylamine) to form an imine-functional organosilicon compound (e.g., N-butyl-3-(1,1,1,5,5,5-hexamethyl-3-((trimethylsilyl)oxy)trisiloxan-3-yl)propan-1-imine) and water as a by-product. In step II), the water may be removed, and in step III) the imine-functional organosilicon compound (e.g., N-butyl-3-(1,1,1,5,5,5-hexamethyl-3-((trimethylsilyl)oxy)trisiloxan-3-yl)propan-1-imine) may be combined with hydrogen, ammonia, and a hydrogenation catalyst under conditions to catalyze reductive amination reaction. N-butylamine is formed as a by-product of the reductive amination reaction, and the N-butylamine can optionally be recycled back to step I). The desired product, e.g., 3-(1,1,1,5,5,5-hexamethyl-3-((trimethylsilyl)oxy)trisiloxan-3-yl)propan-1-amine) also forms in step III).

Optional Step—Hydroformylation to form Aldehyde-Functional Organosilicon Compound Example

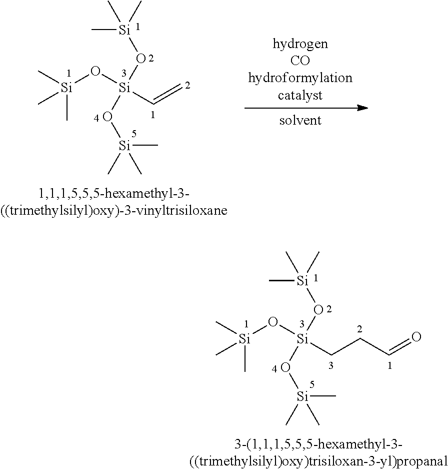 [SMILES: C=C[Si](O[Si](C)(C)C)(O[Si](C)(C)C)O[Si](C)(C)C ; C[Si](C)(C)O[Si](CCC=O)(O[Si](C)(C)C)O[Si](C)(C)C]

### Step I)—Dehydrative Imine Generation Reaction Example

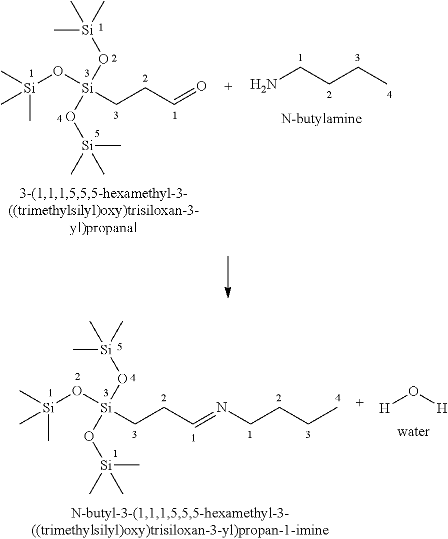

Step II) Remove water and optionally isolate N-butyl-3-(1,1,1,5,5,5-hexamethyl-3-((trimethylsily)oxy)trisiloxan-3-yl)propan-1-imine.

### Step III) Reductive Amination Reaction Example

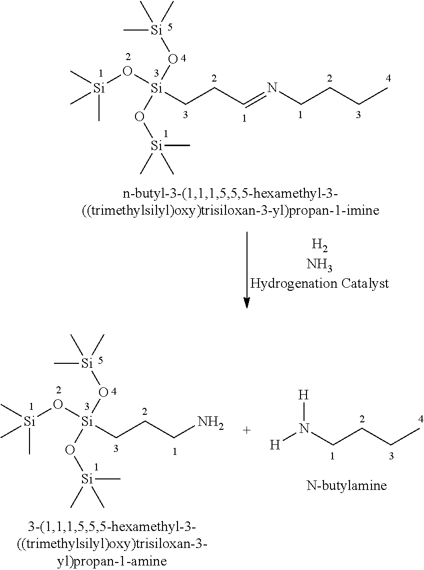

### Amino-Functional Organosilicon Compound

The amino-functional organosilicon compound prepared as described above has, per molecule, at least one primary amino-functional group covalently bonded to silicon. Alternatively, the amino-functional organosilicon compound may have, per molecule, more than one primary amino-functional group covalently bonded to silicon. The primary amino-functional group, R^{N}, may have formula:

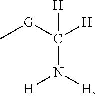

where G is a divalent hydrocarbon group free of aliphatic unsaturation that has 2 to 8 carbon atoms, as described and exemplified above. The amino-functional organosilicon compound can have any one of the formulas above for (L) the imine-functional organosilicon compound, wherein at least one R¹ is preplaced with the group R^{N}.

The amino-functional organosilicon compound prepared as described above may comprise (N1) an amino-functional silane of formula (N1-1): R^{N}ₓSiR⁴₍₄₋ₓ₎, where R^{N}, R⁴ and subscript x are as described above. Amino-functional silanes are exemplified by amino-functional trialkylsilanes such as (aminopropyl)-trimethylsilane, (aminopropyl)-triethylsilane, and (butylamino)-trimethylsilane.

Alternatively, the amino-functional organosilicon compound may comprise (N2) an amino-functional polyorganosiloxane. Said amino-functional polyorganosiloxane may be cyclic, linear, branched, resinous, or a combination of two or more thereof. Said amino-functional polyorganosiloxane may comprise unit formula (N2-1): (R⁴₃SiO_{1/2})ₐ(R⁴₂R^{N}SiO_{1/2})_{b}(R⁴₂SiO_{2/2})_{c}(R⁴R^{N}SiO_{2/2})_{d}(R⁴SiO_{3/2})ₑ(R^{N}SiO_{3/2})_{f}(SiO_{4/2})_{g}(ZO_{1/2})ₕ; where each R^{N} is an independently selected primary amino-functional group of the formula described above, and R⁴, Z, and subscripts a, b, c, d, e, f, g, and h are as described above for formula (B2-1).

Alternatively, (N2) the amino-functional polyorganosiloxane may comprise (N2-2) a linear polydiorganosiloxane having, per molecule, at least one primary amino-functional group; alternatively at least two primary amino-functional groups (e.g., when in the formula (N2-1) for the amino-functional polyorganosiloxane above, subscripts e=f=g=0). For example, said polydiorganosiloxane may comprise unit formula (N2-3): (R⁴₃SiO_{1/2})ₐ(R^{N}R⁴₂SiO_{1/2})_{b}(R⁴₂SiO_{2/2})_{c}(R¹R⁴SiO_{2/2})_{d}, where R^{N} is as described above, and R⁴ and are subscripts a, b, c, and d are as described above for formula (E2-3).

Alternatively, the linear amino-functional polydiorganosiloxane of unit formula (N2-3) may be selected from the group consisting of: unit formula (N2-4): (R⁴₂R^{N}SiO_{1/2})₂(R⁴₂SiO_{2/2})ₘ(R⁴R^{N}SiO_{2/2})ₙ, unit formula (N2-5): (R⁴₃SiO_{1/2})₂(R⁴₂SiO_{2/2})ₒ(R⁴R^{N}SiO_{2/2})ₚ, or a combination of both (N2-4) and (N2-5).

In formulae (N2-4) and (N2-5), R^{N} is as described above, and R⁴ and subscripts m, n, o, and p are as described above for formulae (E2-4) and (E2-5).

The amino-functional polyorganosiloxane (N2) may comprise an amino-functional polydiorganosiloxane such as i) bis-dimethyl(aminopropyl)siloxy-terminated polydimethylsiloxane, ii) bis-dimethyl(aminopropyl)siloxy-terminated poly(dimethylsiloxane/methyl(aminopropyl)siloxane), iii) bis-dimethyl(aminopropyl)siloxy-terminated polymethyl(aminopropyl)siloxane, iv) bis-trimethylsiloxy-terminated poly(dimethylsiloxane/methyl(aminopropyl)siloxane), v) bis-trimethylsiloxy-terminated polymethyl(aminopropyl)siloxane, vi) bis-dimethyl(aminopropyl)siloxy-terminated poly(dimethylsiloxane/methylphenylsiloxane/methyl(aminopropyl)siloxane), vii) bis-dimethyl(aminopropyl)siloxy-terminated poly(dimethylsiloxane/methylphenylsiloxane), viii) bis-dimethyl(aminopropyl)siloxy-terminated poly(dimethylsiloxane/diphenylsiloxane), ix) bis-phenyl,methyl,(aminopropyl)-siloxy-terminated polydimethylsiloxane, x) bis-dimethyl(aminoheptyl)siloxy-terminated polydimethylsiloxane, xi) bis-dimethyl(aminoheptyl)siloxy-terminated poly(dimethylsiloxane/methyl(aminoheptylsiloxane), xii) bis-dimethyl(aminoheptyl)siloxy-terminated polymethyl(aminoheptyl)siloxane, xiii) bis-trimethylsiloxy-terminated poly(dimethylsiloxane/methyl(aminoheptyl)siloxane), xiv) bis-trimethylsiloxy-terminated polymethyl(aminoheptyl)siloxane, xv) bis-dimethyl(aminoheptyl)-siloxy terminated poly(dimethylsiloxane/methylphenylsiloxane/methyl(aminoheptyl)siloxane), xvi) bis-dimethyl(aminopropyl)siloxy-terminated poly(dimethylsiloxane/methyl(aminoheptyl)siloxane), xvii) bis-dimethyl(aminoheptyl)-siloxy-terminated poly(dimethylsiloxane/methylphenylsiloxane), xviii) dimethyl(aminoheptyl)-siloxy-terminated poly(dimethylsiloxane/diphenylsiloxane), and xix) a combination of two or more of i) to xviii).

Alternatively, (N2) the amino-functional polyorganosiloxane may be cyclic, e.g., when in unit formula (N2-1), subscripts a=b=c=e=f=g=h=0. The (N2-6) cyclic amino-functional polydiorganosiloxane may have unit formula (N2-7): (R⁴R^{N}SiO_{2/2})_{d}, where R^{N} and R⁴ are as described above, and subscript d may be 3 to 12, alternatively 3 to 6, and alternatively 4 to 5. Examples of cyclic amino-functional polydiorganosiloxanes include 2,4,6-trimethyl-2,4,6-tri(aminopropyl)-cyclotrisiloxane, 2,4,6,8-tetramethyl-2,4,6,8-tetra(aminopropyl)-cyclotetrasiloxane, 2,4,6,8,10-pentamethyl-2,4,6,8,10-penta(aminopropyl)-cyclopentasiloxane, and 2,4,6,8,10,12-hexamethyl-2,4,6,8,10,12-hexa(aminopropyl)-cyclohexasiloxane.

Alternatively, (N2-6) the cyclic amino-functional polydiorganosiloxane may have unit formula (N2-8): (R⁴₂SiO_{2/2})_{c}(R⁴R^{N}SiO_{2/2})_{d}, where R⁴ and R^{N} are as described above, subscript c is >0 to 6 and subscript d is 3 to 12. Alternatively, in formula (N2-8), a quantity (c+d) may be 3 to 12. Alternatively, in formula (N2-8), c may be 3 to 6, and d may be 3 to 6.

Alternatively, (N2) the amino-functional polyorganosiloxane may be (N2-9) oligomeric, e.g., when in unit formula (N2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as formula (N2-6).

Examples of linear amino-functional polyorganosiloxane oligomers may have formula (N2-10):

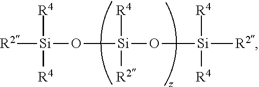

where R⁴ is as described above, each R^{2″} is independently selected from the group consisting of R⁴ and R^{N}, with the proviso that at least one R^{2″}, per molecule, is R^{N}, and subscript z is 0 to 48. Alternatively, subscript z may be 0 to 4; alternatively 0 to 1; and alternatively 0. Alternatively, when z=0 in formula (N2-10), the amino-functional polyorganosiloxane oligomer may have formula (N2-10a):

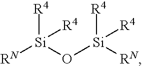

where R⁴ and R^{N} are as described above. Examples of linear amino-functional polyorganosiloxane oligomers include 1,3-di(aminopropyl)-1,1,3,3-tetramethyldisiloxane; 1,1,1,3,3-pentamethyl-3-(aminopropyl)-disiloxane; and 1,1,1,3,5,5,5-heptamethyl-3-(aminopropyl)-trisiloxane.

Alternatively, the amino-functional polyorganosiloxane oligomer may be branched. The branched oligomer may have general formula (N2-11): R^{N}SiR¹²₃, where R^{N} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (L2-11) when each R¹² is R¹³, the branched polyorganosiloxane oligomer has the following structure (N2-11a):

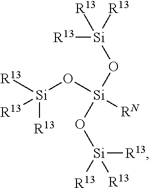

where R^{N} and R¹³ are as described above. Alternatively, in formula (N2-11a), each R^{N} may be aminopropyl, aminobutyl, or aminoheptyl, and each R¹³ may be methyl.

Alternatively, in formula (N2-11) when each R¹² is —OSi(R¹⁴)₃, each R¹⁴ may be —OSi(R¹⁵)₃ moieties such that the branched polyorganosiloxane oligomer has the following structure (B2-11b):

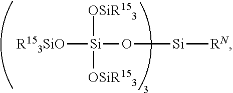

where R^{N} and R¹⁵ are as described above. Alternatively, each R¹⁵ may be an R¹³, as described above, and each R¹³ may be methyl.

Alternatively, in formula (N2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴) may each be —OSi(R¹⁵)₃ moieties such that the branched polyorganosiloxane oligomer has the following structure (N2-11c):

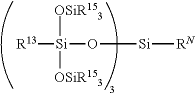

where R^{N}, R¹³, and R¹⁵ are as described above. Alternatively, each R¹⁵ may be an R¹³, and each R¹³ may be methyl.

Alternatively, in formula (N2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of are —OSiR¹³(R¹⁴)₂. Alternatively, each R¹⁴ in —OSiR¹³(R¹⁴)₂ may be —OSi(R⁵)₃ such that the branched polyorganosiloxane oligomer has the following structure (N2-11d):

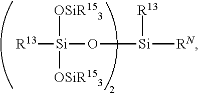

where R^{N}, R¹³, and R¹⁵ are as described above. Alternatively, each R¹⁵ may be an R¹³, and each R¹³ may be methyl. Alternatively, the branched polyorganosiloxane may have 3 to 16 silicon atoms per molecule, alternatively 4 to 16 silicon atoms per molecule, and alternatively 4 to 10 silicon atoms per molecule. Examples of amino-functional branched polyorganosiloxane oligomers include 3-(3,3,3-trimethyl-112-disiloxaneyl)propan-1-amine, which has formula

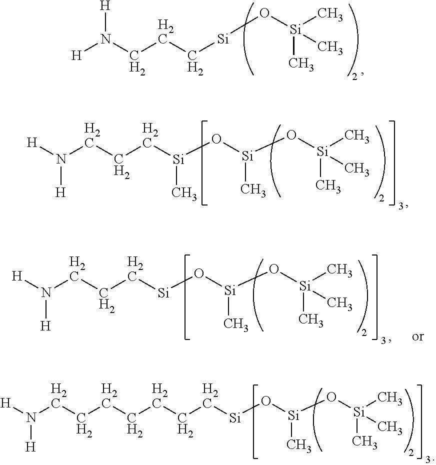

Alternatively, (N2) the amino-functional polyorganosiloxane may be branched, such as the branched oligomer described above and/or a branched amino-functional polyorganosiloxane that may have, e.g., more amino groups per molecule and/or more polymer units than the branched oligomer described above (e.g., in formula (N2-1) when the quantity (a+b+c+d+e+f+g)>50). The branched amino-functional polyorganosiloxane may have (in formula (N2-1)) a quantity (e+f+g) sufficient to provide >0 to 5 mol % of trifunctional and/or quadrifunctional units to the branched amino-functional polyorganosiloxane.

For example, the branched amino-functional polyorganosiloxane may comprise a Q branched polyorganosiloxane of unit formula (N2-13): (R⁴₃SiO_{1/2})_{q}(R⁴₂R^{N}SiO_{1/2})ᵣ(R⁴₂SiO_{2/2})ₛ(SiO_{4/2})ₜ, where R^{N} is as described above, and R⁴ and subscripts q, r, s, and t are as described above for (E2-13).

Alternatively, the branched amino-functional polyorganosiloxane may comprise formula (N2-14): [R^{N}R⁴₂Si—(O—SiR⁴₂)ₓ—O]_{(4-w)}—Si—[O—(R⁴₂SiO)ᵥSiR⁴₃]_{w}, where R^{N} is as described above, and R⁴ and subscripts v, w, and x are as described above with respect to formula (E2-14). Alternatively, in this formula (N2-14), each R⁴ is independently selected from the group consisting of methyl and phenyl, and each R^{N} has the formula above, wherein G has 2, 3, or 6 carbon atoms.

Alternatively, the branched amino-functional polyorganosiloxane for (N2-11) may comprise a T branched polyorganosiloxane (silsesquioxane) of unit formula (N2-15): (R⁴₃SiO_{1/2})ₐₐ(R^{N}R⁴₂SiO_{1/2})_{bb}(R⁴₂SiO_{2/2})_{cc}(R^{N}R⁴SiO_{2/2})ₑₑ(R⁴SiO_{3/2})_{dd}, where R^{N} is as described above, and R⁴ and subscripts aa, bb, cc, dd, and ee are as described above for unit formula (E2-15).

Alternatively, (N2) the amino-functional polyorganosiloxane may comprise an amino-functional polyorganosiloxane resin, such as an amino-functional polyorganosilicate resin and/or an amino-functional silsesquioxane resin. The amino-functional polyorganosilicate resin comprises monofunctional units (“M″” units) of formula R^{M″}₃SiO_{1/2} and tetrafunctional silicate units (“Q” units) of formula SiO_{4/2}, where each R^{M″} may be independently selected from the group consisting of R⁴ and R^{N} as described above. Alternatively, each R^{M″} may be selected from the group consisting of an alkyl group, an amino-functional group of the formula for R^{N} shown above, and an aryl group. Alternatively, each R^{M″} may be selected from methyl, (aminopropyl), (aminobutyl), and phenyl. Alternatively, at least one-third, alternatively at least two thirds of the R^{M″} groups are methyl groups. Alternatively, the M″ units may be exemplified by (Me₃SiO_{1/2}), (Me₂PhSiO_{1/2}), and (Me₂R^{N}SiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

The amino-functional polyorganosilicate resin comprises the M″ and Q units described above, and the polyorganosilicate resin further comprises units with silicon bonded hydroxyl groups, and/or hydrolyzable groups, described by moiety (ZO_{1/2}), above, and may comprise neopentamer of formula Si(OSiR^{M″}₃)₄, where R^{M″} is as described above, e.g., the neopentamer may be tetrakis(trimethylsiloxy)silane. ²⁹Si NMR and ¹³C NMR spectroscopies may be used to measure hydroxyl and alkoxy content and molar ratio of M″ and Q units, where said ratio is expressed as {M″(resin)}/{Q(resin)}, excluding M″ and Q units from the neopentamer. M″/Q ratio represents the molar ratio of the total number of triorganosiloxy groups (M″ units) of the resinous portion of the polyorganosilicate resin to the total number of silicate groups (Q units) in the resinous portion. M″/Q ratio may be 0.5/1 to 1.5/1, alternatively 0.6/1 to 0.9/1.

The Mn of the amino-functional polyorganosilicate resin depends on various factors including the types of hydrocarbon groups represented by R^{M″} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively >3,000 Da to 8,000 Da. Alternatively, Mn of the polyorganosilicate resin may be 3,500 Da to 8,000 Da.

Alternatively, the polyorganosilicate resin may comprise unit formula (N2-17): (R⁴₃SiO_{1/2})ₘₘ(R⁴₂R^{N}SiO_{1/2})ₙₙ(SiO_{4/2})ₒₒ(ZO_{1/2})ₕ, where Z, R⁴, and R^{N}, and subscript h are as described above and subscripts mm, nn and oo have average values such that mm≥0, nn>0, oo>0, and 0.5≤(mm+nn)/oo 4. Alternatively, 0.6≤(mm+nn)/oo≤4; alternatively 0.7≤(mm+nn)/oo≤4, and alternatively 0.8≤(mm+nn)/oo≤4.

Alternatively, (N2) the amino-functional polyorganosiloxane may comprise (N2-18) an amino-functional silsesquioxane resin, i.e., a resin containing trifunctional (T″) units of unit formula: (R⁴₃SiO_{1/2})ₐ(R⁴₂R^{N}SiO_{1/2})_{b}(R⁴₂SiO_{2/2})_{c}(R⁴R^{N}SiO_{2/2})_{d}(R⁴SiO_{3/2})ₑ(R^{N}SiO_{3/2})_{f}(ZO_{1/2})ₕ; where R⁴ and R^{N} are as described above, subscript f>1, 2<(e+f)<10,000; 0<(a+b)/(e+f)<3; 0<(c+d)/(e+f)<3; and 0<h/(e+f)<1.5. Alternatively, the amino-functional silsesquioxane resin may comprise unit formula (N2-19): (R⁴SiO_{3/2})ₑ(R^{N}SiO_{3/2})_{f}(ZO_{1/2})ₕ, where R⁴, R^{N}, Z, and subscripts h, e and f are as described above. Alternatively, the amino-functional silsesquioxane resin may further comprise difunctional (D″) units and said amino-functional silsesquioxane resin may comprise units of formulae (R⁴₂SiO_{2/2})_{c}(R⁴R^{N}SiO_{2/2})_{d} in addition to the T units described above, i.e., a D″T″ resin, where subscripts c and d are as described above. Alternatively, the amino-functional silsesquioxane resin may further comprise monofunctional (M″) units of formulae (R⁴₃SiO_{1/2})ₐ(R⁴₂R^{N}SiO_{1/2})_{b}, i.e., an M″D″T″ resin, where subscripts a and b are as described above for unit formula (E2-1).

Alternatively, (N) the amino-functional organosilicon compound may comprise unit formula (N3-1): [(R¹_{(3-gg)}R^{N}_{gg}Si)_{ff}NH_{(3-ff)}]ₕₕ, where R^{N} is as described above; each R¹ is independently selected from the group consisting of an alkyl group and an aryl group as described above; each subscript ff is independently 1 or 2 as described above; subscript gg is independently 0, 1, or 2 as described above; and subscript h has a value such that 1<hh<10 as described above.

The amino-functional organosilicon compound, prepared in step III) of the process described herein may be any one of the amino-functional organosilicon compounds described above. Alternatively, the reductive amination reaction product may comprise a mixture of two or more of the amino-functional organosilicon compounds.

Alternatively, in the process described herein may be used to produce a hydrolytically unstable amino-functional organosilicon compound. The hydrolytically unstable amino-functional organosilicon compound may be, for example, any one of (N1) the amino-functional silanes and/or (N2) the amino-functional polyorganosiloxanes of any of the formulas shown above, where at least one R⁴ is a hydrocarbonoxy group or an acyloxy group; any (N3) amino-functional silazane; or any amino-functional polyorganosiloxane oligomer of formula (N2-10a) or (N2-11a), as described and exemplified above.

### Examples

These examples are provided to illustrate the invention to one of ordinary skill in the art and should not be construed to limit the scope of the invention set forth in the claims. Starting materials used in the examples are described below in Table 1.

TABLE 1
Starting Materials

| Type | Name/Chemical Description | Source |
|---|---|---|
| Solvent | Methanol/CH₃OH | Sigma-Aldrich |
| Solvent | Toluene, PHR1317/C₇H₈ | Sigma-Aldrich |
| Solvent | Heptane/C₇H₁₆ | Sigma-Aldrich |
| Solvent | Isopropanol/(CH₃)₂CHOH | Sigma-Aldrich |
| Hydrogenation | Rh/C/Rhodium on carbon | Sigma-Aldrich |
| Catalyst | | |
| Hydrogenation | Ni-5256P catalyst/Nickel catalyst | BASF |
| Catalyst | | |
| Hydrogenation | Co-0179/Cobalt catalyst | BASF |
| Catalyst | | |
| Hydro- | (Acetylacetonato) | Commercially |
| formylation | dicarbonylrhodium(I)/ | available |
| Catalyst | Rh(acac)(CO)2 | |
| Precursor | | |
| Ligand 1 | 6,6′-[[3,3′,5,5′-tetrakis(1,1- | TDCC |
| | dimethylethyl)-1,1′- | |
| | bipheny1]-2,2′-diyl]bis(oxy)]bis- | |
| | dibenzo[d,f] | |
| | [1,3,2]dioxaphosphepin | |
| Vinyl | DVTMS/1,3- | DSC |
| functional | divinyltetramethyldisiloxane | |
| siloxane | | |
| Vinyl | MD^{Vi}M, | DSC |
| functional | vinylmethylbis(trimethylsiloxy)silane/ | |
| siloxane | {(CH₃)₃SiO_{1/2}}₂ | |
| | { (CH₃)(CH₂═CH)SiO_{2/2}} | |
| Vinyl | M^{vi}D₇M^{vi}/3,3′- | DSC |
| functional | (1,1,3,3,5,5,7,7,9,9,11, | |
| siloxane | 11,13,13,15,15,17,17- | |
| | octadecamethylnonasiloxane- | |
| | 1,17-diyl)dipropanal | |
| Vinyl | M^{vi}D₃₂₈M^{vi}/Bis- | DSC |
| functional | vinyldimethylsiloxy-terminated | |
| siloxane | polydimethylsiloxane with DP = 328 | |
| Vinyl | M^{vi}D₅₅₈M^{vi}/Bis- | DSC |
| functional | vinyldimethylsiloxy-terminated | |
| siloxane | polydimethylsiloxane with DP = 558 | |
| Amine Source | Ammonia/NH₃ | commercially |
| | | available |
| Primary | n-butylamine/(C₄H₉)NH₂ | Sigma- |
| Amine Source | | Aldrich |
| Dialdehyde- | 3,3′-(1,1,3,3- | Example 1, |
| siloxane A | tetramethyldisiloxane-1,3- | below. |
| | diyl)dipropanal/C10H22O3Si2 | |
| MD^{Pr-ald}M | 3-(1,1,1,3,5,5,5- | Example 30, |
| | heptamethyltrisiloxan- | |
| | 3-yl)propanal/C10H26O3Si3 | below. |
| M^{Pr-ald} | Propylaldehyde terminated | Example 36, |
| D-M^{Pr-ald} | PDMS (DP = 7)/ | below |
| | bis(propyl-aldehyde)-terminated | |
| | polydimethylsiloxane, | |
| | M^{Pr-ald} D₇M^{Pr-ald} | |
| M^{Pr-ald} | Propylaldehyde terminated | Example 26, |
| D₅₅₈M^{Pr-ald} | PDMS (DP = 560)/ | below. |
| | bis(propyl-aldehyde)-terminated | |
| | polydimethylsiloxane, | |
| | M^{Pr-ald} D₅₅₈M^{Pr-ald} | |
| M^{Pr-ald} | Propylaldehyde terminated | Example 28, |
| D₃₂₈M^{Pr-ald} | PDMS (DP = 330)/ | below. |
| | bis(propyl-aldehyde)-terminated | |
| | polydimethylsiloxane, | |
| | M^{Pr-ald} D₃₂₈M^{Pr-ald} | |

In this Reference Example 1, 3,3′-(1,1,3,3-tetramethyldisiloxane-1,3-diyl)dipropanal of formula

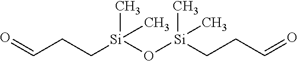

was synthesized as follows. In a nitrogen filled glovebox, Rh(acac)(CO)2 (25.2 mg), Ligand 1 (150.5 mg) and toluene (17.07 g) were added into a 30 mL glass vial with a magnetic stir bar. The mixture was stirred on a stir plate until a homogeneous solution formed. This catalyst solution was transferred to an air-tight syringe with a metal valve and subsequently removed from the glove box. In a ventilated fume hood, 1,3-divinyltetramethyldisiloxane (1000 g) was loaded to a 2 L Autoclave reactor. The reactor was sealed and loaded into the holder. The reactor was pressurized with nitrogen up to 100 psig (689.5 kPa) via the dip-tube and was carefully relieved through a valve connected to the headspace. This step was repeated three times for inertion of reactor headspace. The reactor was then pressure tested by pressurizing to 300 psig (2068.4 kPa) with nitrogen. After the pressure was released, the catalyst solution was added to the reactor via the sample loading port. The reactor was pressurized with syngas to 100 psig (689.5 kPa) and then released for three times prior to being pressurized to 80 psig (551.6 kPa) via the dip-tube. Reaction temperature was set to 50° C. until gas uptake slowed then set temp to 80° C. Agitation rate was set to 800 RPM. The intermediate cylinder containing syngas and the reactor were connected when the desired temperature was reached. The pressure was set to 100 psig (689.5 kPa). The reaction progress was monitored by a data logger which measured the pressure in the 300 mL intermediate cylinder as it supplied syngas to the reactor via a pressure reducing regulator. >98% conversion was observed after 22.5 hours. The n/i ratio was determined by ¹H NMR analysis of the final product.

In this Comparative Example 2, 18 g of the 3,3′-(1,1,3,3-tetramethyldisiloxane-1,3-diyl)dipropanal prepared as described in Example 1 was loaded in a 300 mL Autoclave reactor with toluene solvent (18 g) and Ni-5256P catalyst (4.1 g). The reactor was sealed and the headspace was inerted with nitrogen. Ammonia (74.6 g, 30 equivalence) was added, and the reactor was pressurized with hydrogen to 550 psig (3792.1 kPa). The reactor was heated to 90° C. and hydrogen was added until pressure was 100 psig (689.5 kPa) higher than reactor pressure at reaction temperature. The reaction pressure was observed to be 940 psig (6481.1 kPa). Reductive amination was carried out at 90° C., 825 RPM for 4 hours. The reactor was cooled and vented. The reaction product was collected and filtered to remove catalyst, and the solvent was removed using a rotary evaporator to collect 17.0 g of concentrated product. The concentrated product was 59.7 wt % 3,3′-(1,1,3,3-tetramethyldisiloxane-1,3-diyl)bis(propan-1-amine) as assayed using GC-FID.

In this Reference Example 3, a bis(propylaldehyde-terminated) polydimethylsiloxane with a DP of 560 and formula

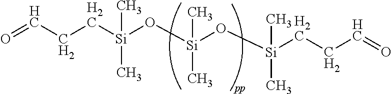

where subscript pp represents the average number of difunctional siloxane units per molecule and has a value of 558, was prepared as follows. In a nitrogen filled glovebox, Rh(acac)(CO)₂ (90.6 mg, 0.350 mmol), Ligand 1 (550 mg, 0.656 mmol) and toluene (51.43 g, 558 mmol) were added into a 120 mL glass bottle with a magnetic stir bar. The mixture was stirred on a stir plate until a homogeneous solution formed. A portion of this solution (1.45 g) was transferred to an air-tight syringe with a metal valve and subsequently removed from the glove box. In a ventilated fume hood, Bis-dimethylvinylsiloxy-terminated polydimethylsiloxane with an average of 558 dimethylsiloxy (D) units per molecule (M^{Vi}₂D₅₅₈) (195.3 g, 4.68 mmol) was loaded to a 300-mL Parr-reactor. The reactor was sealed and loaded into the holder. The reactor was pressurized with nitrogen up to 100 psi (689.5 kPa) via the dip-tube and was carefully relieved through a valve connected to the headspace for three times. The reactor was then pressure tested by pressurizing to 300 psi (2068.4 kPa) with nitrogen. After the pressure was released, the catalyst solution was added to the reactor via the sample loading port. The reactor was pressurized with syngas to 100 psi (689.5 kPa) and then released for three times prior to being pressurized 80 psi (551.6 kPa) via the dip-tube. Reaction temperature was set to 90° C. Agitation rate was set to 600 RPM. The intermediate cylinder containing syngas and the reactor were connected when the desired temperature was reached. The pressure was set to 100 psi (689.5 kPa). The reaction progress was monitored by a data logger which measured the pressure in the 300 ml intermediate cylinder as it supplied syngas to the reactor via a pressure reducing regulator. The reaction was run for four hours. The resulting product contained bis(propylaldehyde-terminated) polydimethylsiloxane with a DP of 560. The product was characterized by ¹H and ²⁹Si NMR.

In this Comparative Example 4, a bis(3-aminopropyl)-terminated poly(dimethylsiloxane) with a DP of 560 of formula:

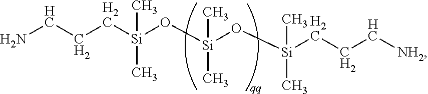

where subscript qq was 558 was prepared as follows. To a 2 L Autoclave reactor was loaded terminal dipropionaldehyde siloxane, (Poly[oxy(dimethylsilylene)], α-[dimethyl(3-oxopropyl)silyl]-ω-[[dimethyl(3-oxopropyl)silyl]oxy] or (C₂H₆OSi)ₙC₁₀H₂₂O₃Si₂ where n=560) prepared as described in Reference Example 3 (595 g), toluene (399 g), and 5 wt % Rh/C (36.5 g). The reactor was sealed, and the headspace was inerted with nitrogen. The mixture was agitated at 820 rpm and ammonia (44 g) was added and the mixture stirred for 18 minutes. The reactor was pressurized to 615 psig (4240.3 kPa) with hydrogen and heated to 60° C. The reactor pressure was 683 psig (4709.1 kPa). The pressure of the reactor was increased to 795 psig (5481.3 kPa) with hydrogen, and the reaction was run for 4 hours with continuous hydrogen addition. The reactor was cooled and vented. The reaction product was collected and filtered to remove catalyst, and the solvent was removed by rotary evaporator to collect 595.8 g of product. The product was characterized by ²⁹Si analysis, GPC, and viscosity. The octamethylcyclotetrasiloxane content was measured by GC analysis. ²⁹Si NMR analysis showed 78%-propyl-NH₂ end capped polydimethylsiloxane.

In this Reference Example 5, 3-(1,1,1,3,5,5,5-heptamethyltrisiloxan-3-yl)propanal was prepared as follows. In a nitrogen filled glovebox, Rh(acac)(CO)₂ (13.6 mg, 0.0525 mmol), Ligand 1 (84.5 mg, 0.101 mmol) and toluene (10.0 g, 108.5 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, vinylmethylbis(trimethylsiloxy)silane (MD^{Vi}M) (1000 g, 4.02 mol) was loaded to a 2-L Autoclave-reactor. The reactor was sealed and loaded into the holder. The reactor was pressurized with nitrogen up to 100 psi (689.5 kPa) via the dip-tube and was carefully relieved through a valve connected to the headspace for three times. The reactor was then pressure tested by pressurizing to 300 psi (2068.4 kPa) with nitrogen. After the pressure was released, the catalyst solution was added to the reactor via the sample loading port. The reactor was pressurized with syngas to 100 psi (689.5 kPa) and then released for three times prior to being pressurized 80 psi (551.6 kPa) via the dip-tube. Reaction temperature was set to 75° C. Agitation rate was set to 800 RPM The intermediate cylinder containing syngas and the reactor were connected when the desired temperature was reached. The pressure was set to 100 psi (689.5 kPa). The reaction progress was monitored by a data logger which measured the pressure in the intermediate cylinder as it supplied syngas to the reactor via a pressure reducing regulator. The resulting product contained 3-(1,1,1,3,5,5,5-heptamethyltrisiloxan-3-yl)propanal (MD^{Pr-ald}M). A portion of the crude 3-(1,1,1,3,5,5,5-heptamethyltrisiloxan-3-yl)propanal (MD^{Pr-ald}M) was purified by vacuum distillation. A vacuum distillation set-up was equipped with a 12 inch (30.48 cm) Vigreux column connected to a 500 3-neck round bottom flask equipped with a PTFE coated magnetic stir bar, an electric heating mantle controlled by a J-CHEM™ controller on the internal temperature measured with a thermoprobe and a 250 mL pre-tared collection flask. A vacuum manifold was connected to the system which included a vacuum gauge and a nitrogen line to adjust the pressure and break vacuum. Water cooling was used on the distillate condenser and a dry-ice trap was in place between the distillation system and the diaphragm vacuum pump to trap lower boiling components. A thermometer was in place to measure the temperature of the overhead vapors. A distillation was conducted by loading crude 3-(1,1,1,3,5,5,5-heptamethyltrisiloxan-3-yl)propanal (MD^{Pr-ald}M) (341.5 g) to the 500 mL reboiler. The distillation was conducted at 2 torr (266.6 Pa) pressure. A lights cut (13 g) was collected at a pot temperature of 76° C. and an overhead temperature of 66° C. The main fraction containing purified 3-(1,1,1,3,5,5,5-heptamethyltrisiloxan-3-yl)propanal (MD^{Pr-ald}M) (243 g) was collected at a pot temperature of 80-85° C. and an overhead temperature of 67-69° C. Bottoms material of 55 g was also recovered.

In this Comparative Example 6, N-(3-(1,1,1,3,5,5,5-heptamethyltrisiloxan-3-yl)propyl)butan-1-amine was synthesized as follows. To a 300 mL Autoclave reactor was loaded 12.0 g 3-(1,1,1,3,5,5,5-heptamethyltrisiloxan-3-yl)propanal prepared as described in Reference Example 5, toluene (48.5 g), n-butylamine (3.8 g) and 5 wt % Rh/C (1.4 g). The reactor was sealed, and the headspace was inerted with nitrogen. The mixture was agitated at 800 rpm for 5 minutes. The reactor was pressurized to 463 psig (3192.3 kPa) with hydrogen and heated to 60° C. The reactor pressure was 452 psig (3116.4 kPa). The pressure of the reactor was increased to 651 psig (4488.5 kPa) with hydrogen, and the reaction was run for 4 hours with continuous hydrogen addition. The reactor was cooled and vented. The reaction product was collected, and the reactor was rinsed with toluene to collect 75.2 g of material. A portion of the material was filtered through a syringe filter, stripped of solvent, and characterized by gas chromatography and by ¹H and ¹³C NMR analysis, which confirmed the presence of N-(3-(1,1,1,3,5,5,5-heptamethyltrisiloxan-3-yl)propyl)butan-1-amine. GC analysis showed the N-(3-(1,1,1,3,5,5,5-heptamethyltrisiloxan-3-yl)propyl)butan-1-amine product present in 86 area %.

In this Working Example 7, 3-(1,1,1,3,5,5,5-heptamethyltrisiloxan-3-yl)propan-1-amine and N-(3-(1,1,1,3,5,5,5-heptamethyltrisiloxan-3-yl)propyl)butan-1-amine was synthesized as follows. To a 300 mL Autoclave reactor was loaded 11.7 g of 3-(1,1,1,3,5,5,5-heptamethyltrisiloxan-3-yl)propanal prepared as described in Reference Example 5, toluene (48.4 g), n-butylamine (3.9 g, 1.25 eq) and 5 wt % Rh/C (1.2 g). The reactor was sealed, and the headspace was inerted with nitrogen. To the mixture was added ammonia (18.3 g, 25 eq.), and the reactor pressure was 114 psig (786 kPa). The mixture was agitated at 800 rpm for 7 minutes. To the reactor was loaded hydrogen to 480 psig (3309.5 kPa), and the hydrogen addition was stopped. The reactor was heated to 60° C. at which point the reaction pressure was 580 psig (3999 kPa). The pressure of the reactor was increased to 798 psig (5502 kPa) with hydrogen, and the reaction was run for 4 hours with continuous hydrogen addition. The reactor was cooled and vented. The reaction product was collected, and the reactor was rinsed with toluene to collect 109.6 g of liquid. A portion of the liquid was filtered through a syringe filter, stripped of solvent, and characterized gas chromatography and by ¹H and ¹³C NMR analysis, which showed: 67.4 GC/FID area % 3-(1,1,1,3,5,5,5-heptamethyltrisiloxan-3-yl)propan-1-amine 18.6 GC/FID area % N-(3-(1,1,1,3,5,5,5-heptamethyltrisiloxan-3-yl)propyl)butan-1-amine, which combined are 86 area % products by GC.

In this Comparative Example 8, 3-(1,1,1,3,5,5,5-heptamethyltrisiloxan-3-yl)propan-1-amine was synthesized as follows. To a 300 mL Autoclave reactor was loaded 12.1 g of 3-(1,1,1,3,5,5,5-heptamethyltrisiloxan-3-yl)propanal prepared as described in Reference Example 30, toluene (48.4 g), and 5 wt % Rh/C (1.3 g). The reactor was sealed, and the headspace was inerted with nitrogen. Agitation at 800 rpm was started, and to the mixture was added ammonia (19.9 g, 26.9 eq.) and the reactor pressure was 117 psig (806.7 kPa). To the reaction was loaded hydrogen to 444 psig (3061.3 kPa), and the hydrogen addition valve closed. The reactor was heated to 60° C. at which point the reaction pressure was 610 psig (4205.8 kPa). The reactor was pressurized to 463 psig (3192.3 kPa) with hydrogen and heated to 60° C. The pressure of the reactor was increased to 816 psig (5626.1 kPa) with hydrogen, and the reaction was run for 4.5 hours with continuous hydrogen addition. The reactor was cooled and vented. The reaction product was collected to yield 60.6 g of liquid. A portion of the liquid was filtered through a syringe filter, stripped of solvent, and characterized gas chromatography and by ¹H and ¹³C NMR and GC/FID analysis confirmed the presence of 3-(1,1,1,3,5,5,5-heptamethyltrisiloxan-3-yl)propan-1-amine in the reaction product. GC analysis showed 79 area % of 3-(1,1,1,3,5,5,5-heptamethyltrisiloxan-3-yl)propan-1-amine product.

Working Example 7 showed improved yield using the process of the present invention, over Comparative Example 8.

In this Working Example 9, a bis(3-aminopropyl)-terminated poly(dimethylsiloxane) with a DP of 560 of formula:

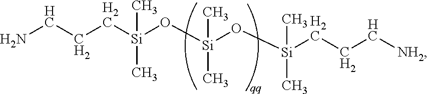

where subscript qq was 558 was prepared as follows. To a glass vessel was loaded terminal dipropionaldehyde siloxane, (Poly [oxy(dimethylsilylene)], α-[dimethyl(3-oxopropyl)silyl]-ω-[[dimethyl(3-oxopropyl)silyl]oxy] or (C₂H₆OSi)ₙC₁₀H₂₂O₃Si₂ where n=558) prepared as described in Reference Example 3 (70.0 g) and toluene (71.0 g) to form a solution. To this solution was loaded n-butylamine (0.51 g, 2.1 eq.) and mixed thoroughly. The mixture became cloudy. MgSO₄ (3.0 g) was added and mixed, and the mixture was held for 16 hours. The mixture was filtered to remove MgSO₄ and provide 140 g of clear liquid. The liquid was analyzed by ¹H NMR to confirm the presence of the butyl imine.

To a 300 mL Autoclave reactor was loaded terminal diimine siloxane, (Poly [oxy(dimethylsilylene)], α-[dimethyl(3-(butylimino)propylsilyl]-ω-[[dimethyl(3-(butylimino)propylsilyl]oxy] or (C₂H₆OSi)ₙC₁₈H₄₀O₃N₂Si₂ where n=558) solution prepared in this Working Example 9 (140 g) and 5 wt % Rh/C (3.5 g). The reactor was sealed, and the headspace was inerted with nitrogen. The mixture was agitated at 800 rpm and ammonia (7.1 g) was added and the mixture stirred for 13 minutes. The reactor was pressurized to 259 psig (1785.7 kPa) with hydrogen and heated to 60° C. The reactor pressure was 290 psig (1999.5 kPa). The pressure of the reactor was increased to 790 psig (5446.9 kPa) with hydrogen, and the reaction was run for 4 hours with continuous hydrogen addition. The reactor was cooled and vented. The reaction product was collected and filtered to remove catalyst, and the solvent was removed by rotary evaporator to collect 70.7 g of product. The product was characterized by ²⁹Si and ¹H NMR analysis. ²⁹Si NMR analysis showed 91% primary amino-functional end capped polydimethylsiloxane.

In this Working Example 10, 50.33 g of 3,3′-(1,1,3,3-tetramethyldisiloxane-1,3-diyl)dipropanal prepared as described in Example 1 was loaded in a 300 mL Autoclave reactor with methanol (15.1 g) and Ni-5256P (6.01 g) and n-butylamine (29.7 g). The reactor was sealed and agitation was started at 400 RPM and the headspace was inerted with nitrogen. The agitation rate was increased to 800 RPM and ammonia (35.3 g, 10 equivalence) was added. The reactor was pressurized with hydrogen to 505 psig. The reactor was heated to 90° C., and hydrogen was added until pressure was 805 psig. Reductive amination was carried out at 90° C. for approximately 16 hours. The reactor was cooled and vented. The reaction product was collected and filtered to remove catalyst, and the solvent was removed using a rotary evaporator to collect 49.8 g of concentrated product. The concentrated product was 72.4 wt % 3,3′-(1,1,3,3-tetramethyldisiloxane-1,3-diyl)bis(propan-1-amine) as assayed using GC-FID.

In this Working Example 11, 50.07 g of 3,3′-(1,1,3,3-tetramethyldisiloxane-1,3-diyl)dipropanal prepared as described in Example 1 was loaded in a 300 mL Autoclave reactor with methanol (15.05 g) and Ni-5256P (6.02 g) and iso-butylamine (29.72 g). The reactor was sealed and agitation was started at 400 RPM and the headspace was inerted with nitrogen. The agitation rate was increased to 820 RPM and ammonia (35.3 g, 10 equivalence) was added. The reactor was pressurized with hydrogen to 506 psig. The reactor was heated to 90° C., and hydrogen was added until pressure was 802 psig. Reductive amination was carried out at 90° C. for approximately 16 hours. The reactor was cooled and vented. The reaction product was collected and filtered to remove catalyst, and the solvent was removed using a rotary evaporator to collect 48.7 g of concentrated product. The concentrated product was 79.2 wt % 3,3′-(1,1,3,3-tetramethyldisiloxane-1,3-diyl)bis(propan-1-amine) as assayed using GC-FID.

In this Working Example 12, 25.1 g of 3,3′-(1,1,3,3-tetramethyldisiloxane-1,3-diyl)dipropanal prepared as described in Example 1 was loaded in a glass vessel with methanol (25.1 g) and 3,3′-(1,1,3,3-tetramethyldisiloxane-1,3-diyl)bis(propan-1-amine) (30.0 g) to form an imine solution. This solution was loaded to a 300 mL Autoclave reactor and Ni-5256P (2.76 g) was added. The reactor was sealed and agitation was started at 820 RPM and the headspace was inerted with nitrogen. The agitation rate was continued at 820 RPM and ammonia (37.3 g) was added. The reactor was pressurized with hydrogen to 519 psig. The reactor was heated to 90° C., and hydrogen was added until pressure was 773 psig. Reductive amination was carried out at 90° C. for approximately 16 hours. The reactor was cooled and vented. The reaction product was collected and filtered to remove catalyst, and the solvent was removed using a rotary evaporator to collect 48.7 g of concentrated product. The concentrated product was 79.2 wt % 3,3′-(1,1,3,3-tetramethyldisiloxane-1,3-diyl)bis(propan-1-amine) as assayed using GC-FID.

### Hydroformylation to Generate Aldehyde of Branched Organosilicon Oligomer

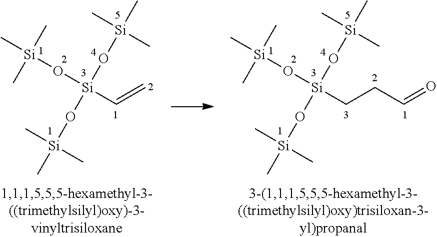

In this Reference Example 13, 3-(1,1,1,5,5,5-hexamethyl-3-((trimethylsilyl)oxy)trisiloxan-3-yl)propanal of formula (above) was synthesized as follows. In a nitrogen filled glovebox, Rh(acac)(CO)2 (47.5 mg), Ligand 1 (294 mg) and toluene (60.2 g) were added into a glass bottle with a magnetic stir bar. The mixture was stirred on a stir plate until a homogeneous solution formed. A portion of this catalyst solution (2.88 g) was transferred to an air-tight syringe with a metal valve and subsequently removed from the glove box. In a ventilated fume hood, 1,1,1,5,5,5-hexamethyl-3-((trimethylsilyl)oxy)-3-vinyltrisiloxane (180 g) was loaded to a 300 mL pressure reactor. The reactor was sealed. While stirring at 600 RPM, the reactor was pressurized with nitrogen up to 100 psig via the dip-tube and was carefully relieved through a valve connected to the headspace. This step was repeated three times for inertion of reactor headspace. The reactor was then pressure tested by pressurizing to 300 psig with nitrogen. After the pressure was released, the catalyst solution was added to the reactor via the sample loading port. The reactor was pressurized with syngas to 100 psig and then released for three times prior to being pressurized to 100 psig via the dip-tube. Reaction temperature was set to 80° C. The agitation rate was set to 600 RPM. The intermediate cylinder containing syngas and the reactor were connected when the desired temperature was reached. The pressure was set to 100 psig. The reaction progress was monitored by a data logger which measured the pressure in the 300 mL intermediate cylinder as it supplied syngas to the reactor via a pressure reducing regulator. >99% conversion was observed after 16 hours. n/i ratio was determined by ¹H NMR analysis of the final product to be 7.5 to 1.

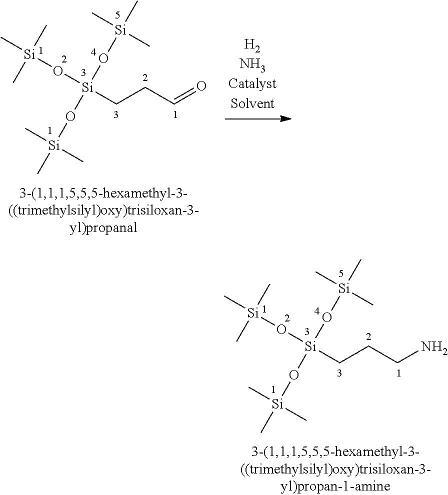 [SMILES: C[Si](C)(C)O[Si](CCC=O)(O[Si](C)(C)C)O[Si](C)(C)C ; C[Si](C)(C)O[Si](CCCN)(O[Si](C)(C)C)O[Si](C)(C)C]

In this Comparative Example 14, 40 g of 3-(1,1,1,5,5,5-hexamethyl-3-((trimethylsilyl)oxy)trisiloxan-3-yl)propanal prepared as described in Example 13 was loaded in a 300 mL Autoclave reactor with THF (40.03 g) and Ni-5256P (3.99 g). The reactor was sealed, and the headspace was inerted with nitrogen. Ammonia (29.0 g, 15 equivalence) was added, and the reactor was pressurized with hydrogen to 530 psig. The reactor was heated to 100° C., and hydrogen was added until pressure was 100 psig higher than reactor pressure at reaction temperature. Reductive amination was carried out at 100° C., 920 psig, 800 RPM for 16 hours. The reactor was cooled and vented. The reaction product was collected and filtered to remove catalyst, and the solvent was removed using a rotary evaporator to collect 33.8 g of concentrated product. The concentrated product was 44.1 wt % 3-(1,1,1,5,5,5-hexamethyl-3-((trimethylsilyl)oxy)trisiloxan-3-yl)propan-1-amine as assayed using GC-FID.

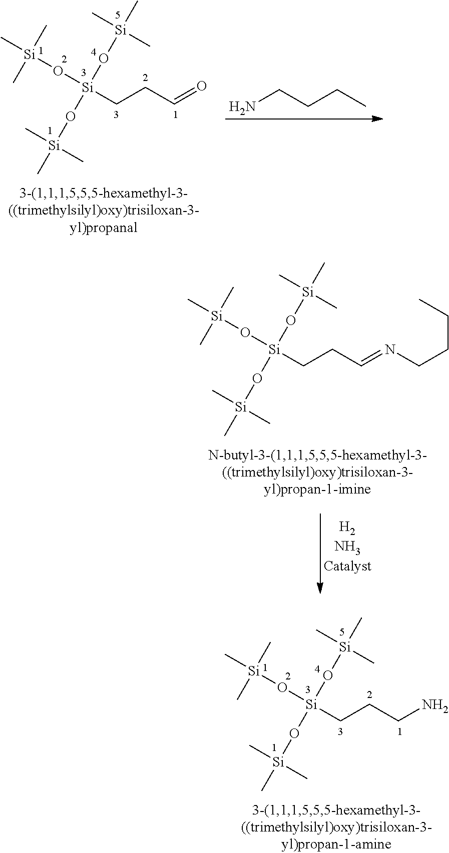

In this Working Example 15, 30 g of 3-(1,1,1,5,5,5-hexamethyl-3-((trimethylsilyl)oxy)trisiloxan-3-yl)propanal prepared as described in Example 13 was loaded to a glass round bottom flask. THF solvent (60 g) was added to form a solution. N-butylamine (6.53 g, 1.05 eq.) was added to the solution while stirring with a PTFE coated magnetic stir bar. A mild exotherm was noted. MgSO₄ was added to adsorb water from the solution. The MgSO₄ was removed by filtration to result in 95 g of solution containing N-butyl-3-(1,1,1,5,5,5-hexamethyl-3-((trimethylsilyl)oxy)trisiloxan-3-yl)propan-1-imine. The imine containing solution was loaded in a 300 mL Autoclave reactor with Ni-5256P catalyst (3.01 g). The reactor was sealed, and the headspace was inerted with nitrogen. Ammonia (21.7 g, 15 equivalence) was added, and the reactor was pressurized with hydrogen to 520 psig. The reactor was heated to 100° C., and hydrogen was added until pressure was 100 psig higher than reactor pressure at reaction temperature. Reductive amination was carried out at 100° C., 925 psig, 800 RPM for 20 hours. The reactor was cooled and vented. The reaction product was collected and filtered to remove catalyst, and the solvent was removed using a rotary evaporator to collect 25.0 g of concentrated product. The concentrated product was 75.9 wt % 3-(1,1,1,5,5,5-hexamethyl-3-((trimethylsilyl)oxy)trisiloxan-3-yl)propan-1-amine as assayed using GC-FID. This Working Example and the Comparative Example immediately preceding it show that yield dramatically increases using the process of this invention instead of attempting to form a primary amino-functional organosilicon compound directly from the corresponding aldehyde-functional organosilicon compound with ammonia.

In this Reference Example 16, T-phenyl resin propanal of formula, M_{0.24}M^{Propanaldehyde}_{0.139}T^{Ph}_{0.62} was synthesized as follows. In a nitrogen filled glovebox, Rh(acac)(CO)2 (48.0 mg), Ligand 1 (311.9 mg) and toluene (59.9 g) were combined to form a homogeneous catalyst solution. A portion of this catalyst solution (5.8 g) was transferred to an air-tight syringe with a metal valve and subsequently removed from the glove box. In a ventilated fume hood, M_{0.24}M^{Vi}_{0.139}T^{Ph}_{0.62} (90 g) dissolved in toluene (90 g) was loaded to a 300 mL pressure reactor. The reactor was sealed. While stirring at 600 RPM, the reactor was pressurized with nitrogen up to 100 psig via the dip-tube and was carefully relieved through a valve connected to the headspace. This step was repeated three times for inertion of reactor headspace. The reactor was then pressure tested by pressurizing to 300 psig with nitrogen. After the pressure was released, the catalyst solution was added to the reactor via the sample loading port. The reactor was pressurized with syngas to 100 psig and then released for three times prior to being pressurized to 100 psig via the dip-tube. Reaction temperature was set to 70° C. The agitation rate was set to 600 RPM. The intermediate cylinder containing syngas and the reactor were connected when the desired temperature was reached. The pressure was set to 100 psig. The reaction progress was monitored by a data logger which measured the pressure in the 300 mL intermediate cylinder as it supplied syngas to the reactor via a pressure reducing regulator. >99% conversion was observed after 16 hours determined by ¹H NMR analysis of the final product. The toluene was removed to leave the product as a viscous liquid.

In this Working Example 17, 25.8 g of M_{0.24}M^{Propanaldehyde}_{0.14}T^{Ph}_{0.62} as described in Example 16 was loaded to a glass round bottom flask. THF solvent (51.6 g) was added to form a solution. N-butylamine (2.55 g, 1.1 eq.) was added to the solution while stirring with a PTFE coated magnetic stir bar. MgSO₄ was added to adsorb water from the solution. The MgSO₄ was removed by filtration to result in a solution containing the corresponding N-butyl imine. The imine containing solution was loaded in a 300 mL Autoclave reactor with 5% Ru/C catalyst (2.6 g). The reactor was sealed, and the headspace was inerted with nitrogen. Ammonia (8.3 g, ˜15 equivalence) was added, and the reactor was pressurized with hydrogen to 530 psig. The reactor was heated to 80° C., and hydrogen was added until the pressure was 880 psig. Reductive amination was carried out at 80° C., 880 psig, 800 RPM for 18.5 hours. The reactor was cooled and vented. The reaction product was collected and filtered to remove catalyst, and the solvent was removed using a rotary evaporator to collect 27.2 g of concentrated product. The concentrated product contained M_{0.24}M^{Propanaldehyde}_{0.139}T^{Ph}_{0.52} as determined by ¹H and ¹³C NMR. This Working Example 17 shows that the process of this invention can be used to make a primary amino-functional polyorganosiloxane resin.

In this Working Example 18, 299.1 g of 3,3′-(1,1,3,3-tetramethyldisiloxane-1,3-diyl)dipropanal prepared as described in Example 1 was loaded to a glass round bottom flask. Isopropanol solvent (898.1 g) was added to form a solution. Iso-butylamine (196.1 g, 2.1 eq.) was added to the solution while stirring with a mechanical stirrer. The resulting imine-functional organosilicon compound in isopropanol solution and ammonia and hydrogen were passed through a continuous tubular (trickle bed) reactor at flow rates of 0.18 mL/min, 0.036 m/min, and 8.6 sccm, respectively. The tubular reactor internal diameter was 3 mm and contained 6.03 g of Ni-5256E catalyst. The reactor was controlled at 100° C. The effluent of the reactor was collected, and volatiles were removed under vacuum to leave a liquid. The liquid contained >50% 3,3′-(1,1,3,3-tetramethyldisiloxane-1,3-diyl)bis(propan-1-amine) as assayed using GC-FID. This Working Example showed that the reductive amination reaction of the present invention can be practiced in a continuous mode without plugging.

In this Comparative Example 19, 300.0 g of 3,3′-(1,1,3,3-tetramethyldisiloxane-1,3-diyl)dipropanal prepared as described in Example 1 was loaded to a glass round bottom flask. Isopropanol solvent (1200 g) was added to form a solution. The resulting aldehyde-functional organosilicon compound in isopropanol solution and ammonia and hydrogen were passed through a continuous tubular (trickle bed) reactor at flow rates of 0.30 mL/min, 0.056 mL/min, and 14 sccm, respectively. The tubular reactor internal diameter was 3 mm and contained 6.0 g of Ni-5256E catalyst. The reactor was controlled at 100° C. The reactor plugged shortly after starting feed flows due the formation of a solid in the reactor and no effluent of the reactor was collected.

Working Example 18 shows the benefit of improved processability when using the process of the present invention over Comparative Example 19.

In this Prophetic Example 20, methanol (30 g) and Ni-5256P (6.0 g) are loaded to a 300 mL Autoclave reactor and the reactor is inerted with nitrogen. Ammonia (35 g, 10 equivalence) is added. The mixture is heated to 110° C. and then hydrogen is added until the pressure reaches 1000 psig. To the stirred reaction mixture (800 RPM) is pumped in 50 g of 3,3′-(1,1,3,3-tetramethyldisiloxane-1,3-diyl)dipropanal prepared as described in Example 1 over a period of 60 minutes. The hydrogen is continuously fed at 1000 psig during this time. After the 3,3′-(1,1,3,3-tetramethyldisiloxane-1,3-diyl)dipropanal addition is complete the reaction is continued at 110° C. and 1000 psig for 2 hours. The reactor is cooled and vented. The reaction product is collected and filtered to remove catalyst, and the solvent is removed using a rotary evaporator to collect concentrated product.

### INDUSTRIAL APPLICABILITY

When performing reductive amination of an aldehyde-functional organosilicon compound with ammonia, a primary imine-functional organosilicon compound is first generated, which is converted to the desired primary amino-functional organosilicon compound via reductive amination. However, primary imine groups are relatively unstable and may also cause self-condensation of the imine-functional organosilicon compound to form higher molecular weight by-products such as triazines and secondary amines, resulting often in significant yield loss. Furthermore, formation of these by-products often increases the viscosity of the product and/or results in the formation of solids, which makes catalyst separation difficult and limits opportunities for performing the reductive amination reaction using continuous reactor apparatus. Methods for minimizing the formation of these by-products are desired to improve yield and process robustness of a reductive amination reaction to produce amino-functional organosilicon compounds. The process described herein addresses this problem by using a primary amine source to generate a secondary imine-functional organosilicon compound. The secondary imine is then treated with excess ammonia, hydrogen, and a hydrogenation reaction catalyst to afford the primary amino-functional organosilicon compound and regenerate the primary amine source, which may be recycled and used in a subsequent dehydrative imine generation reaction.

In addition, during a reductive amination reaction of an aldehyde-functional organosilicon compound with ammonia, one molar equivalent of water per mole of aldehyde-functionality is generated as a by-product of the primary imine group formation. Certain amino-functional organosilicon compounds are hydrolytically unstable and will react with water under the conditions employed for this reductive amination reaction, and this instability results in a side reaction that can generate additional undesirable by-products. Silanes functionalized with alkoxy groups or acyloxy groups, silazanes, and branched and linear oligomeric siloxanes, such as oligomeric amino-functional siloxanes derived from branched aldehyde-functional siloxane oligomers (E2-10) or (E2-11) described above are more prone to side reactions in the presence of water than other amino-functional polyorganosiloxanes.

Without wishing to be bound by theory, it is thought that the ability to remove water in step II) of the process described herein (i.e., after secondary imine group and water formation via the dehydrative imine generation reaction begins in step I) and before reductive amination reaction in step III) of the process described herein can improve yield of the primary amino-functional organosilicon compound as product even when using hydrolytically unstable aldehyde-functional organosilicon compounds as starting materials and/or generating hydrolytically unstable imine-functional organosilicon compounds and hydrolytically unstable amino-functional organosilicon compounds. Furthermore, due to the improved stability of secondary imine groups over primary imine groups, the present invention provides opportunities to improve the yield and robustness of the reductive amination reaction by providing options for addressing the problems described above. Secondary imine groups are less prone to degrade via self-condensation, which in turn increases the yield of the process while also enabling alternative processing options such as the use of continuous reactors. In addition, the increased stability of the secondary imine-functional organosilicon compound intermediate allows for the water generated during the secondary imine group formation to optionally be removed using a variety of techniques including distillation or the use of a drying agent. The ability to remove the water during the early stages of the process minimizes or eliminates formation of certain by-products when using organosilicon compounds that are less hydrolytically stable in the process. Lastly, the generation of the secondary imine-functional organosilicon compound as intermediate protects the aldehyde group (of the aldehyde-functional organosilicon compound starting material) from oxidative decomposition.

Without wishing to be bound by theory, it is thought that the process may also provide low or no salt side product streams, shorter reaction times and/or lower cyclic siloxane by-product generation than conventional condensation reaction processes. Furthermore, the hydroformylation and reductive amination can be done in one single reactor without necessity to isolate intermediates, and may have minimal process steps.

Without wishing to be bound by theory, it is thought that another advantage of the present invention is that the amino-functional organosilicon compound produced has a high proportion of linear amino-functional groups, and that this is because aldehyde-functional organosilicon compounds having branched aldehyde moieties will react and degrade during the process described herein, such that they can be easily removed. Furthermore, the amino-functional organosilicon compound produced may have reduced cyclic siloxane (e.g., octamethylcyclotetrasiloxane, D4) content as compared to amino-functional organosilicon compounds produced via condensation chemistry using carboxylic acid catalysts or equilibration chemistry using base catalysts.

### Definitions and Usage of Terms

All amounts, ratios, and percentages herein are by weight, unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated by the context of specification. The singular includes the plural unless otherwise indicated. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The term “hydrolytically unstable” refers to any organosilicon compound that reacts with water at a temperature <120° C. Hydrolytically unstable organosilicon compounds herein include any organosilicon compounds used or generated, which reacts with water at a temperature <120° C. Examples include any (B) alkenyl-functional organosilicon compound, any (E) aldehyde-functional organosilicon compound, any (L) imine-functional organosilicon compound, and any primary amino-functional organosilicon compound prepared as described herein that meets one or more of the following criteria: i) one or more R⁴ per molecule is acyloxy or hydrocarbonoxy; ii) the organosilicon compound is a silazane; and/or ii) any oligomeric polyorganosiloxane of formula (B2-10a), (E2-10a), (L2-10a), (N2-10a) such as 1,3-di(aminopropyl)-1,1,3,3-tetramethyldisiloxane, (B2-11a), (E2-11a), (L2-11a), or (N2-11a), such as 3-(3,3,3-trimethyl-112-disiloxaneyl)propan-1-amine, as shown above. The abbreviations used herein have the definitions in Table Z.

TABLE Z
Abbreviations

| Abbreviation | Definitions |
|---|---|
| acac | acetyl acetonate |
| ° C. | degrees Celsius |
| cm | centimeter |
| D | Difunctional siloxy unit, trimethylsiloxy |
| | unit of formula Me₂SiO_{2/2} |
| D^{Pr-ald} | Difunctional siloxy unit, propylaldehyde, |
| | methylsiloxy unit of formula (Pr- |
| | ald)(Me)SiO_{2/2} |
| DP | degree of polymerization |
| DSC | Dow Silicones Corporation of Midland, |
| | Michigan, USA |
| D^{vi} | Difunctional siloxy unit, vinylmethylsiloxy |
| | unit of formula (Vi)(Me)SiO_{2/2} |
| Et | ethyl |
| FTIR | Fourier transform infra-red |
| g | gram |
| GPC | gel permeation chromatography |
| h | hour |
| kPa | kiloPascals |
| L | liter |
| M | Monofunctional siloxy unit, |
| | trimethylsiloxy unit of formula R₃SiO_{1/2} or |
| | Me₃SiO_{1/2} |
| M^{Pr-ald} | Monofunctional siloxy unit, propyladehyde, |
| | dimethylsiloxy unit of formula |
| | (Pr-ald)(Me₂)SiO_{1/2} |
| M^{vi} | Monofunctional siloxy unit, |
| | vinyldimethylsiloxy unit of formula |
| | (Vi)(Me₂)SiO_{1/2} |
| Me | methyl |
| mg | milligram |
| min | minute |
| mL or ml | milliliter |
| mm | millimeter |
| mmol | millimole |
| Mn | number average molecular weight measured by GPC |
| mol | mole |
| Mw | weight average molecular weight measured by GPC |
| mPa · s | milliPascal seconds |
| NBD | norbornadiene |
| NMR | nuclear magnetic resonance |
| Pa | Pascal |
| Ph | phenyl |
| ppm | parts per million by weight |
| Pr | propyl |
| Pr-ald | propyl-aldehyde |
| psi | pounds per square inch |
| Q | tetrafunctional siloxy unit of formula SiO_{4/2} |
| RPM or rpm | revolutions per minute |
| RT | room temperature of 25 ± 5° C. |
| TDCC | The Dow Chemical Company of Midland, |
| | Michigan, USA |
| THF | tetrahydrofuran |
| μm | micrometer |
| Vi | vinyl |

The following test methods were used herein. FTIR: The concentration of silanol groups present in the polyorganosiloxane resins (e.g., polyorganosilicate resins and/or silsesquioxane resins) was determined using FTIR spectroscopy according to ASTM Standard E-168-16. GPC: The molecular weight distribution of the polyorganosiloxanes was determined by GPC using an Agilent Technologies 1260 Infinity chromatograph and toluene as a solvent. The instrument was equipped with three columns, a PL gel 5 μm 7.5×50 mm guard column and two PLgel 5 μm Mixed-C 7.5×300 mm columns. Calibration was made using polystyrene standards. Samples were made by dissolving polyorganosiloxanes in toluene (˜1 mg/mL) and then immediately analyzing the solution by GPC (1 m/min flow, 35° C. column temperature, 25-minute run time). ²⁹Si NMR: Alkenyl content of starting material (B) can be measured by the technique described in “The Analytical Chemistry of Silicones” ed. A. Lee Smith, Vol. 112 in Chemical Analysis, John Wiley & Sons, Inc. (1991). Viscosity: Viscosity may be measured at 25° C. at 0.1 to 50 RPM on a Brookfield DV-III cone & plate viscometer with #CP-52 spindle, e.g., for polymers (such as certain (B2) alkenyl-functional polyorganosiloxanes and (E2) aldehyde-functional polyorganosiloxanes) with viscosity of 120 mPa·s to 250,000 mPa·s. One skilled in the art would recognize that as viscosity increases, rotation rate decreases and would be able to select appropriate spindle and rotation rate.

The aldehyde-functional organosilicon compounds, and reductive amination reaction product mixtures, in the examples above, were analyzed by ¹H, ¹³C NMR and ²⁹Si NMR, GC/MS, GPC and viscosity. The conversion and yield in the examples above were mainly based on ¹H NMR data.

### Embodiments of the Invention

In a first embodiment, a process for preparing an imine-functional organosilicon compound comprises:
I) combining, under conditions to effect a dehydrative imine generation reaction, starting materials comprising
   (E) an aldehyde-functional organosilicon compound;
   (F1) a primary amine source;
   optionally (G) a hydrogenation catalyst;
   optionally (J) a solvent; and
   optionally (K) a drying agent;
   thereby forming a dehydrative imine generation reaction product comprising (L) an imine-functional organosilicon compound and water;
optionally II) removing water; and
optionally isolating (L) the imine-functional organosilicon compound.

In a second embodiment a process for making an amino-functional organosilicon compound comprises: practicing the process of the first embodiment; and
III) combining, under conditions to catalyze reductive amination reaction, starting materials comprising
   (L) the imine-functional organosilicon compound,
   (F2) ammonia,
   optionally (G) the hydrogenation catalyst,
   (H) hydrogen,
   optionally (J) the solvent, and
   optionally (K) the drying agent,
   with the proviso that (G) the hydrogenation catalyst is combined in at least one of step I) and step III);
   thereby forming a reductive amination reaction product comprising the amino-functional organosilicon compound and the primary amine source.

In a third embodiment, the process of the first embodiment or the second embodiment further comprises preparing (E) the aldehyde-functional organosilicon compound by a hydroformylation process comprising:
I) combining, under conditions to catalyze hydroformylation reaction, starting materials comprising
   (A) a gas comprising hydrogen and carbon monoxide,
   (B) an alkenyl-functional organosilicon compound, and
   (C) a rhodium/bisphosphite ligand complex catalyst, where the bisphosphite ligand has formula

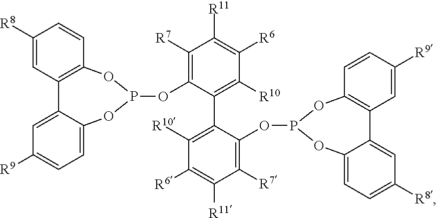

where
   R⁶ and R^{6′} are each independently selected from the group consisting of hydrogen, an alkyl group of 1 to 20 carbon atoms, a cyano group, a halogen group, and an alkoxy group of 1 to 20 carbon atoms;
   R⁷ and R^{7′} are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
   R⁸, R^{8′}, R^{9′} and R^{9′} are each independently selected from the group consisting of hydrogen, an alkyl group, a cyano group, a halogen group, and an alkoxy group, and
   R¹⁰ R^{10′}, R¹¹, and R^{11′} are each independently selected from the group consisting of hydrogen or and alkyl group; thereby forming a hydroformylation reaction product comprising (E) an aldehyde-functional organosilicon compound;
optionally 2) recovering (C) the rhodium/bisphosphite ligand complex catalyst from the hydroformylation reaction product comprising (E) the aldehyde-functional organosilicon compound; and
optionally 3) isolating (E) the aldehdye-functional organosilicon compound.

In a fourth embodiment, in the process of any one of the first to third embodiments, the aldehyde-functional organosilicon compound is hydrolytically unstable, e.g., as defined above.

In a fifth embodiment, in the process of the fourth embodiment, the aldehyde-functional organosilicon compound has formula

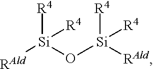

where each R⁴ is independently selected from the group consisting of an alkyl group of 1 to 18 carbon atoms and an aryl group of 6 to 18 carbon atoms; and each R^{Ald} is an independently selected group of the formula

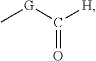

where G is a divalent hydrocarbon group free of aliphatic unsaturation that has 2 to 8 carbon atoms.

In a sixth embodiment, in the process of the fifth embodiment, each R⁴ is methyl, and R^{Ald} is selected from the group consisting of propylaldehyde, butylaldehyde, and heptylaldehyde.

In a seventh embodiment, in the process of any one of the first to fourth embodiments, the aldehyde-functional organosilicon compound has formula

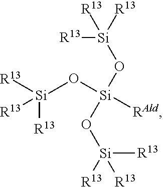

where each R¹³ is independently selected from the group consisting of an alkyl group of 1 to 18 carbon atoms and an aryl group of 6 to 18 carbon atoms; and each R^{Ald} is an independently selected group of the formula

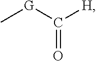

where G is a divalent hydrocarbon group free of aliphatic unsaturation that has 2 to 8 carbon atoms.

In an eighth embodiment, in the process of the seventh embodiment, each R¹³ is methyl and R^{Ald} is selected from the group consisting of propylaldehyde, butylaldehyde, and heptylaldehyde.

In a ninth embodiment, in the process of any one of the first to third embodiments, the imine-functional organosilicon compound is hydrolytically unstable, e.g., as defined above.

In a tenth embodiment, in the process of the ninth embodiment, the imine-functional organosilicon compound has formula

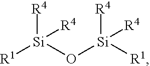

where each R⁴ is independently selected from the group consisting of an alkyl group of 1 to 18 carbon atoms and an aryl group of 6 to 18 carbon atoms; and each R¹ is an independently selected group of the formula

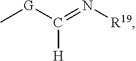

where G is a divalent hydrocarbon group free of aliphatic unsaturation that has 2 to 8 carbon atoms, and R¹⁹ is selected from an alkyl group of 1 to 18 carbon atoms, an aryl group of 6 to 18 carbon atoms, and an organosilicon moiety.

In an eleventh embodiment, in the process of the tenth embodiment, each R⁴ is methyl, G is a divalent hydrocarbon group of 2, 3, or 6 carbon atoms, and each R¹⁹ is an alkyl group of 1 to 4 carbon atoms.

In a twelfth embodiment, in the process of the eleventh embodiment, the imine-functional organosilicon compound has formula

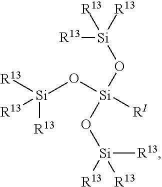

where each R¹³ is independently selected from the group consisting of an alkyl group of 1 to 18 carbon atoms and an aryl group of 6 to 18 carbon atoms; and R¹ is a group of the formula

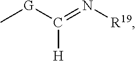

where G is a divalent hydrocarbon group free of aliphatic unsaturation that has 2 to 8 carbon atoms, and R¹⁹ is selected from the group consisting of an alkyl group of 1 to 18 carbon atoms, an aryl group of 6 to 18 carbon atoms, and an organosilicon moiety.

In a thirteenth embodiment, in the process of the twelfth embodiment, each R¹³ is methyl, G is a divalent hydrocarbon group of 2, 3, or 6 carbon atoms, and each R¹⁹ is an alkyl group of 1 to 4 carbon atoms.

In a fourteenth embodiment, in the process of the second embodiment, the amino-functional organosilicon compound is hydrolytically unstable, e.g., as defined above.

In a fifteenth embodiment, in the process of the fourteenth embodiment, the amino-functional organosilicon compound has formula

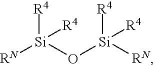

where each R⁴ is independently selected from the group consisting of an alkyl group of 1 to 18 carbon atoms and an aryl group of 6 to 18 carbon atoms; each R^{N} is an independently selected primary amino group of formula

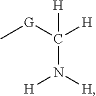

where G is a divalent hydrocarbon group free of aliphatic unsaturation that has 2 to 8 carbon atoms.

In a sixteenth embodiment, in the process of the fifteenth embodiment, each R⁴ is methyl, and R^{N} is selected from the group consisting of aminopropyl, aminobutyl, and aminoheptyl.

In a seventeenth embodiment, in the process of the fourteenth embodiment, the amino-functional organosilicon compound has formula

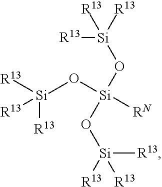

where each R¹³ is independently selected from the group consisting of an alkyl group of 1 to 18 carbon atoms and an aryl group of 6 to 18 carbon atoms; and R^{N} is a primary amino group of formula

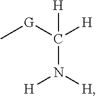

where G is a divalent hydrocarbon group free of aliphatic unsaturation that has 2 to 8 carbon atoms.

In an eighteenth embodiment, in the process of the seventeenth embodiment, each R¹³ is methyl, and R^{N} is selected from the group consisting of aminopropyl, aminobutyl, and aminoheptyl.

1. A process for preparing an imine-functional organosilicon compound, wherein the process comprises:
I) combining, under conditions to effect a dehydrative imine generation reaction, starting materials comprising
an aldehyde-functional organosilicon compound, which has, per molecule, at least one aldehyde-functional group covalently bonded to silicon, wherein the aldehyde-functional group covalently bonded to silicon has formula 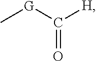
where G is a divalent hydrocarbon group free of aliphatic unsaturation that has 2 to 8 carbon atoms,
a primary amine source,
optionally a solvent, and
optionally a hydrogenation catalyst,
thereby forming a reaction product comprising an imine-functional organosilicon compound and water;
with the proviso that step I) is performed in the absence of hydrogen when the hydrogenation catalyst is present in step I); and
optionally II) removing water generated by the dehydrative imine generation reaction in step I); and
optionally isolating the imine-functional organosilicon compound.

2. A process for preparing an amino-functional organosilicon compound, wherein the process comprises:
Preparing the imine-functional organosilicon compound by practicing the process of claim 1; and
III) combining, under conditions to catalyze a reductive amination reaction, starting materials comprising
the imine-functional organosilicon compound,
ammonia,
hydrogen,
optionally the hydrogenation catalyst, and
optionally the solvent,
with the proviso that the hydrogenation catalyst is present in at least one of step I) and step III);
thereby forming a reaction product comprising the amino-functional organosilicon compound.

3. The process of claim 1, further comprising forming the aldehyde-functional organosilicon compound before step I) by a process comprising: combining, under conditions to catalyze hydroformylation reaction, starting materials comprising
(A) a gas comprising hydrogen and carbon monoxide,
(B) an alkenyl-functional organosilicon compound, and
(C) a rhodium/bisphosphite ligand complex catalyst, where the bisphosphite ligand has formula 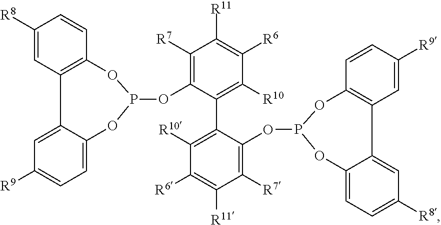
where
R⁶ and R^{6′} are each independently selected from the group consisting of hydrogen, an alkyl group of 1 to 20 carbon atoms, a cyano group, a halogen group, and an alkoxy group of 1 to 20 carbon atoms;
R⁷ and R^{7′} are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
R⁸, R^{8′}, R^{9′} and R^{9′} are each independently selected from the group consisting of hydrogen, an alkyl group, a cyano group, a halogen group, and an alkoxy group, and
R¹⁰ R^{10′}, R¹¹, and R^{11′} are each independently selected from the group consisting of hydrogen or and alkyl group; thereby forming a hydroformylation reaction product comprising the aldehyde-functional organosilicon compound.

4. The process of claim 1, further comprising recovering the aldehyde-functional organosilicon compound before step I).

5. The process of claim 1, where the primary amine source is selected from the group consisting of:
an organic primary amine of formula: R¹⁸NH₂, where R¹⁸ is an alkyl group of 1 to 18 carbon atoms or an aryl group of 6 to 18 carbon atoms, and
a primary amino-functional organosilicon compound.

6. The process of claim 1, where the hydrogenation catalyst is a heterogeneous hydrogenation catalyst comprising a metal selected from the group consisting of Co, Cu, Fe, Ni, Ir, Pd, Pt, Rh, Ru, and a combination of two or more thereof.

7. The process of claim 1, where amount of the hydrogenation catalyst is <1 weight % to 50 weight %, based on weight of the aldehyde-functional organosilicon compound.

8. The process of claim 2, where in step III) one or both of conditions (i) and (ii) is satisfied, where condition (i) is that H₂ pressure is 10 psig (68.9 kPa) to 1500 psig (10,342 kPa), and condition (ii) is that temperature is 0° C. to 200° C.

9. The process of claim 2, further comprising pre-treating the hydrogenation catalyst before step III).

10. The process of claim 2, further comprising: IV) recovering the amino-functional organosilicon compound from the reaction product during and/or after step III).

11. The process of claim 2, further comprising: V) recovering the primary amine source generated in step III), and optionally recycling the primary amine source in step I).

12. The process of claim 2, where step III) is performed in a continuous mode, optionally in a trickle bed reactor.

13. The process of claim 1, where step II) is present, and step II) is performed before and/or during step I).

14. The process of claim 13, where the aldehyde-functional organosilicon compound reacts with water at a temperature <120° C.

15.-20. (canceled)

21. An imine-functional organosilicon compound prepared by the process of claim 5, wherein the imine-functional organosilicon compound has, per molecule, at least one imine-functional group covalently bonded to silicon, wherein the imine-functional group covalently bonded to silicon has formula 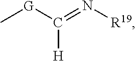
where G is the divalent hydrocarbon group free of aliphatic unsaturation that has 2 to 8 carbon atoms, and R¹⁹ is selected from an alkyl group or an aryl group when the organic primary amine is used as the primary amine source, and R¹⁹ is an organosilicon moiety when the amino-functional organosilicon compound is used as the primary amine source.

22. The imine-functional organosilicon compound of claim 21, wherein imine-functional organosilicon compound may comprises an imine-functional silane of formula: R¹ₓSiR⁴₍₄₋ₓ₎, where R¹ is the imine-functional group of formula 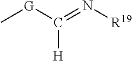
where G and R¹⁹ are as described above, each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4.

23. The imine-functional organosilicon compound of claim 21, wherein imine-functional organosilicon compound comprises unit formula:
(R⁴₃SiO_{1/2})ₐ(R⁴₂R¹SiO_{1/2})_{b}(R⁴₂SiO_{2/2})_{c}(R⁴R¹SiO_{2/2})_{d}(R⁴SiO_{3/2})ₑ(R¹SiO_{3/2})_{f}(SiO_{4/2})_{g}(ZO_{1/2})ₕ; where
each R¹ is an independently selected imine-functional group of formula 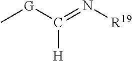
where G and R¹⁹ are as described above;
each R⁴ is independently selected from the group consisting of a hydrogen atom, an alkyl group of 1 to 18 carbon atoms and an aryl group of 6 to 18 carbon atoms;
each Z is independently selected from the group consisting of a hydrogen atom, an alkyl group of 1-18 carbon atoms and an aryl group of 6-18 carbon atoms;
subscripts a, b, c, d, e, f, and g represent numbers of each unit in the unit formula and have values such that
subscript a≥0,
subscript b≥0,
subscript c≥0,
subscript d≥0,
subscript e≥0,
subscript f≥0, and
subscript g≥0;
10,000≥(a+b+c+d+e+f+g)≥2, and
a quantity (b+d+f)≥1, and
subscript h has a value such that 0≤h/(e+f+g)≤1.5.

24. The imine-functional organosilicon compound of claim 23, where the imine-functional polyorganosiloxane is selected from the group consisting of:
a cyclic imine-functional polyorganosiloxane having a unit formula selected from the group consisting of (R⁴R¹SiO_{2/2})_{d}, where subscript d is 3 to 12; (R⁴₂SiO_{2/2})_{c}(R⁴R¹SiO_{2/2})_{d}, where c is 0 to 6 and d is 3 to 12; and a combination thereof;
a linear imine-functional polyorganosiloxane comprising unit formula: (R⁴₃SiO_{1/2})ₐ(R⁴₂R¹SiO_{1/2})_{b}(R⁴₂SiO_{2/2})_{c}(R⁴R¹SiO_{2/2})_{d}, where a quantity (a+b)=2, a quantity (b+d)≥1, and a quantity (a+b+c+d)≥2;
a branched imine-functional polyorganosiloxane comprising unit formula: R¹SiR¹²₂, where each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹3; where each R¹⁵ is selected from R¹³, —OSi(R¹⁶)₃, and —[OSiR¹³₂]ᵢᵢOSiR¹3; where each R¹⁶ is selected from R¹³ and —[OSiR¹³₂]ᵢᵢOSiR¹3; and where subscript ii has a value such that 0≤ii≤100, with the proviso that at least two of R¹² are —OSi(R¹4)
an imine-functional polyorganosilicate resin comprising unit formula: (R⁴₃SiO_{1/2})ₘₘ(R⁴₂R¹SiO_{1/2})ₙₙ(SiO_{4/2})ₒₒ(ZO₁/2)ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4; and
an imine-functional silsesquioxane resin comprising unit formula: (R⁴₃SiO_{1/2})ₐ(R⁴₂R¹SiO_{1/2})_{b}(R⁴₂SiO_{2/2})_{c}(R⁴R¹SiO_{2/2})_{d}(R⁴SiO_{3/2})ₑ(R¹SiO_{3/2})_{f}(ZO₁/2)ₕ; where f>1, 2<(e+f)<10,000; 0<(a+b)/(e+f)<3; 0<(c+d)/(e+f)<3; and 0<h/(e+f)<1.5; and
wherein
R¹ and R⁴ are as described above.
